(19) United States
(12) Patent Application Publication
(10) Pub. No.: US 2026/0332469 A1
(43) Pub. Date: Oct. 22, 2026

(54) METHODS AND SYSTEM FOR AI-ASSISTED ANOMALY DETECTION AND ROOT CAUSE ANALYSIS IN A RADIO ACCESS NETWORK

(71) Applicant: Aira Technologies, Inc., Saratoga, CA (US)

(72) Inventors: Jash RATHOD, San Jose, CA (US); Nirmal Chandrasekaran, San Jose, CA (US); Ravikiran Gopalan, Saratoga, CA (US); Leela Venkata Sai K B Kasyap Varanasi, Sunnyvale, CA (US); Gautham Hariharan, Sunnyvale, CA (US); Sandeep Kesireddy, San Jose, CA (US); Siva Sellathurai, Union City, CA (US)

(21) Appl. No.: 19/652,098

(22) Filed: Apr. 20, 2026

Related U.S. Application Data
(60) Provisional application No. 63/791,828, filed on Apr. 21, 2025.

(51) Int. Cl. H04L 41/0631; H04L 41/16

(52) U.S. Cl. CPC H04L 41/0645; H04L 41/16

(57) ABSTRACT

Methods and a system for detecting anomalies and identifying root causes in a radio access network (RAN) are disclosed. The method includes receiving time-series data of key performance indicators (KPIs) from a target cell site, estimating missing or future KPI values, and constructing a hierarchical dependency structure linking performance management (PM) counters to primary KPIs. Anomaly detection is performed by identifying KPIs with abnormal temporal behavior and isolating critical anomalous KPIs that significantly impact a primary KPI. A cell site's fingerprint is generated using anomaly indicators and contextual data, including alarms, configuration changes, support tickets, and neighbor cell site information. The fingerprint is classified into a root cause category using a trained machine learning model. A large language model (LLM) suite then generates a root cause summary, optionally including recommended remedial actions.

### CROSS-REFERENCE TO RELEVANT APPLICATION

This non-provisional application claims priority to U.S. Provisional Patent Application No. 63/791,828, filed Apr. 21, 2025, entitled “Methods And System For AI-Assisted Anomaly Detection And Root Cause Analysis In A Radio Access Network,” the entire disclosure of which is incorporated herein by reference in its entirety.

### TECHNICAL FIELD

The present invention relates generally to wireless communication systems, and more particularly to systems and methods for anomaly detection (AD) and performing root cause analysis (RCA) in Radio Access Networks (RANs) using key performance indicators (KPIs), machine learning-based estimations, and domain-specific knowledge.

### BACKGROUND

Wireless network operators continuously monitor and maintain the performance of thousands of distributed radio access network (RAN) cell sites. Each cell site reports numerous KPIs and low-level performance management (PM) counters reflecting real-time network and cell site health. Traditional methods for identifying performance issues rely on reactive rules or manual inspection, resulting in delays and incomplete diagnosis of complex issues. Furthermore, operators often lack direct observability into certain user equipment (UE)-based metrics or delayed composite indicators like Cell Quality Metrics (COM), limiting their ability to proactively detect anomalies and determine root causes. As networks become more complex and customer expectations for uptime increase, there is a growing need for intelligent, scalable solutions that not only detect performance degradation in near real time, but also explain contributing factors and suggest remedial actions.

### SUMMARY

Embodiments of the present disclosure relate to systems, methods, and computer-readable media for detecting anomalous network conditions in a radio access network (RAN). In some embodiments, a computer system receives time-series data including a plurality of fundamental metrics collected from a network cell site, generates estimated values for one or more derived metrics using a predictive machine learning model based on the time-series data, and accesses a hierarchical dependency graph representing learned statistical relationships among the fundamental metrics, the derived metrics, and a primary performance indicator associated with the network cell site. The computer system may compute anomaly scores for the fundamental metrics and the derived metrics based on deviations from corresponding expected values during a target time window, detect degradation of the primary performance indicator during the target time window, calculate an attribution score for at least one fundamental metric or derived metric based on the anomaly score of the respective metric and a graph-based relationship between the respective metric and the primary performance indicator in the hierarchical dependency graph, and generate an anomaly indication identifying the at least one fundamental metric or derived metric as contributing to the degradation of the primary performance indicator.

In some embodiments, generating the estimated values for the one or more derived metrics includes applying the predictive machine learning model to an input sequence of values of the fundamental metrics sampled over a sliding time window to output predicted values for the one or more derived metrics for a current time step or a future time step. In some embodiments, the predictive machine learning model may include one or more of a recurrent neural network, a long short-term memory network, a gated recurrent unit network, a transformer-based sequence model, or a temporal convolutional network. In some embodiments, the predictive machine learning model may be trained to learn temporal and statistical relationships based on historical time-series data sampled at uniform time intervals. The one or more derived metrics may include, for example, a user equipment quality metric, a cell quality-derived metric, or a latency-related metric.

In some embodiments, the hierarchical dependency graph is constructed as a directed acyclic graph in which nodes represent the fundamental metrics, the one or more derived metrics, and the primary performance indicator, and directed edges define graph-based relationships among those nodes. In some embodiments, the graph may be iteratively refined by computing estimated values of higher-level metrics using lower-level metrics based on current edge weights of the directed edges, comparing the estimated values with corresponding historical observed values to compute an estimation error, and adjusting the current edge weights to minimize the estimation error. In some embodiments, the graph-based relationship used to calculate the attribution score includes at least one weighted path in the hierarchical dependency graph connecting the at least one fundamental metric or derived metric to the primary performance indicator.

In some embodiments, the expected values used for anomaly scoring are determined based on one or more of a statistical baseline generated from historical data for a comparable time-of-day or day-of-week window, a forecasted value generated by a time-series prediction model, or a predefined threshold. In some embodiments, the generated anomaly indication is presented and stored as an incident record in a network operations system, the incident record identifying degradation of the primary performance indicator and the at least one fundamental metric or derived metric contributing to the degradation.

In some embodiments, the computer system further generates a performance-based fingerprint for the network cell site. The performance-based fingerprint may include a vectorized representation of anomaly scores of the fundamental metrics and the one or more derived metrics, numerical encodings of recent configuration management changes, alarms, and support ticket activity associated with the network cell site, and one or more semantic embeddings generated by processing textual content of the alarms, the support ticket activity, and the recent configuration management changes. In some embodiments, non-anomalous metrics are assigned predetermined default values to preserve a consistent fingerprint dimensionality. A root-cause classifier model may then be applied to the performance-based fingerprint to classify degradation of the primary performance indicator into a root cause category.

In some embodiments, the computer system further identifies one or more neighboring cell sites based on geospatial proximity to the network cell site, retrieves operational records including neighbor support tickets, neighbor alarm logs, and neighbor configuration change records for the one or more neighboring cell sites, and processes the operational records using a semantic embedding model to convert textual content into neighbor vector representations. In some embodiments, the system identifies an environmental or system-wide contributing cause to degradation of the primary performance indicator of the network cell site based on the neighbor vector representations.

In some embodiments, the fundamental metrics are assigned to a cluster of network cell sites or metric series having similar temporal behavior, and the predictive machine learning model is selected from a plurality of predictive machine learning models respectively trained for different clusters. This clustered modeling approach may improve scalability and predictive accuracy by selecting a predictive model that is better aligned with the temporal behavior of the corresponding metric series.

Further embodiments are directed to systems including one or more processors and memory storing instructions that, when executed, cause the system to perform any of the foregoing operations, as well as to non-transitory computer-readable media storing instructions that, when executed by one or more processors, cause a computer system to perform any of the foregoing operations.

### BRIEF DESCRIPTION OF THE DRAWINGS

The technology disclosed herein, in accordance with one or more various embodiments, is described in detail with reference to the following figures (hereafter referred to as “FIG.”). The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example system environment for detecting anomalies and performing root-cause analysis in a radio access network, in accordance with some embodiments.

FIG. 2 illustrates an example hierarchical dependency graph including fundamental metrics, derived metrics, and a primary performance indicator, in accordance with some embodiments.

FIG. 3 illustrates an example method for detecting an anomalous network condition based on derived metrics, anomaly scores, and graph-based attribution, in accordance with some embodiments.

FIG. 4 illustrates an example process for constructing and iteratively refining a hierarchical dependency graph using estimation error, in accordance with some embodiments.

FIG. 5A illustrates a high-level architectural view of a two-prong root-cause analysis pipeline, in accordance with some embodiments.

FIG. 5B illustrates a more detailed implementation view of a root-cause analysis pipeline including performance-based fingerprint generation and neighboring-site contextual analysis, in accordance with some embodiments.

FIG. 6 illustrates a more specific implementation of a two-prong root-cause analysis workflow combining KPI-driven analysis and contextual operational-record analysis, in accordance with some embodiments.

FIG. 7 illustrates an example modular large language model suite architecture for anomaly detection, root-cause analysis, and recommendation generation in a radio access network, in accordance with some embodiments.

FIG. 8 illustrates an example agent-level implementation of a modular large language model suite for anomaly detection, root-cause analysis, graph refinement, and recommendation generation in a radio access network, in accordance with some embodiments.

FIG. 9 illustrates an example clustered modeling approach for selecting predictive machine learning models based on temporal behavior of metric series, in accordance with some embodiments.

FIG. 10 illustrates an example computing device in which any of the embodiments described herein may be implemented.

### DETAILED DESCRIPTION

Maintaining reliable performance in a Radio Access Network (RAN) has become increasingly difficult as network architectures, traffic patterns, and service demands grow in complexity. Network operators commonly monitor RAN behavior using performance management (PM) counters, key performance indicators (KPIs), and other metrics associated with throughput, accessibility, latency, coverage quality, and user experience. In practice, degradation of an important service-level indicator at a cell site may depend on multiple lower-level metrics that evolve over time and interact in non-obvious ways.

Existing anomaly detection and root cause analysis (RCA) techniques for RAN operations suffer from several technical limitations. One limitation is that dependency relationships among PM counters, KPIs, and higher-level performance indicators are often not explicitly defined, incomplete, or too dynamic to be captured accurately by static rules. As a result, conventional approaches frequently rely on manually defined correlations, threshold logic, or heuristic expert analysis, which may fail to capture statistical, temporal, and latent relationships among network metrics. This can reduce diagnostic accuracy and lead to incomplete identification of metrics contributing to service degradation.

Another technical limitation arises from incomplete observability of network conditions. In many RAN deployments, some metrics are unavailable, delayed, asynchronously collected, or only partially observable due to measurement limitations, reporting delays, or privacy-related constraints. Conventional monitoring systems that rely primarily on directly observed metrics may therefore operate on incomplete or stale data. This partial observability can degrade anomaly detection performance, increase false positives and false negatives, and produce incorrect attribution of root causes.

Existing RCA approaches also often analyze a target cell site in isolation or use limited contextual information. However, many service degradations are influenced by factors that are distributed across neighboring sites, environmental conditions, alarm patterns, configuration changes, or operational events reflected in support records. Conventional systems frequently lack a technical framework for combining metric-based anomaly evidence with contextual operational data in a manner that supports consistent and scalable RCA across large RAN deployments.

Embodiments of the present invention provide an advanced system and method for anomaly detection and two-prong root cause analysis in a RAN. The disclosed system addresses the aforementioned limitations by employing a multi-layered analytical architecture capable of operating effectively under conditions of partial observability, unknown KPI dependencies, and asynchronous KPI availability.

This disclosure describes a novel integrated system and pipeline for inferring KPI dependencies and estimating missing or delayed data, enabling continuous observability across the RAN. This pipeline dynamically constructs a hierarchical KPI dependency structure-represented as a directed acyclic graph (DAG) by learning statistical and temporal relationships from historical data. Machine learning models are employed to estimate unobservable KPIs and forecast future KPI trajectories, ensuring that anomaly detection remains robust even when direct measurements are unavailable or delayed.

Building on this foundation, the system applies a hybrid anomaly detection approach that compares observed and estimated KPI values against learned baselines or predictive models to detect abnormal temporal behavior. The system assigns anomaly scores or flags to each KPI and further identifies a subset of critical anomalous KPIs that most significantly contribute to degradation in a primary performance metric. This contribution analysis is guided by the learned KPI dependency graph and incorporates attribution techniques to isolate the most impactful causes of degradation.

To determine root causes, the system conducts a dual-pronged root cause analysis (RCA). The first path leverages KPI anomalies, configuration changes, alarm records, and ticket data to generate a detailed cell site fingerprint. This fingerprint is enriched using semantic embeddings and is categorized using a combination of supervised and unsupervised machine learning models trained on historical RCA data and expert-defined taxonomies. The second path gathers contextual information from the target cell site and spatially adjacent cell sites—including support tickets, alarm logs, and maintenance records—and processes them using a suite of large language models (LLMs) to uncover environmental or systemic contributors that may not be evident from KPI data alone.

These diverse analytical streams converge within a modular LLM suite, which includes a master LLM agent or orchestrator (or simply “master LLM” in the following description) that coordinates multiple specialized LLM agents. Each agent is tuned to process specific types of input, such as alarms, configuration logs, or ticket histories. The LLM suite connects to a library of supporting machine learning models, domain-specific knowledge bases, and structured data sources, including performance and configuration databases. Some LLM agents are capable of generating and executing structured queries (e.g., SQL) to autonomously retrieve relevant telemetry data as needed to complete an RCA task. The master LLM synthesizes the results of these agents into a coherent root cause summary, presented in natural language and, optionally, accompanied by ranked remedial actions.

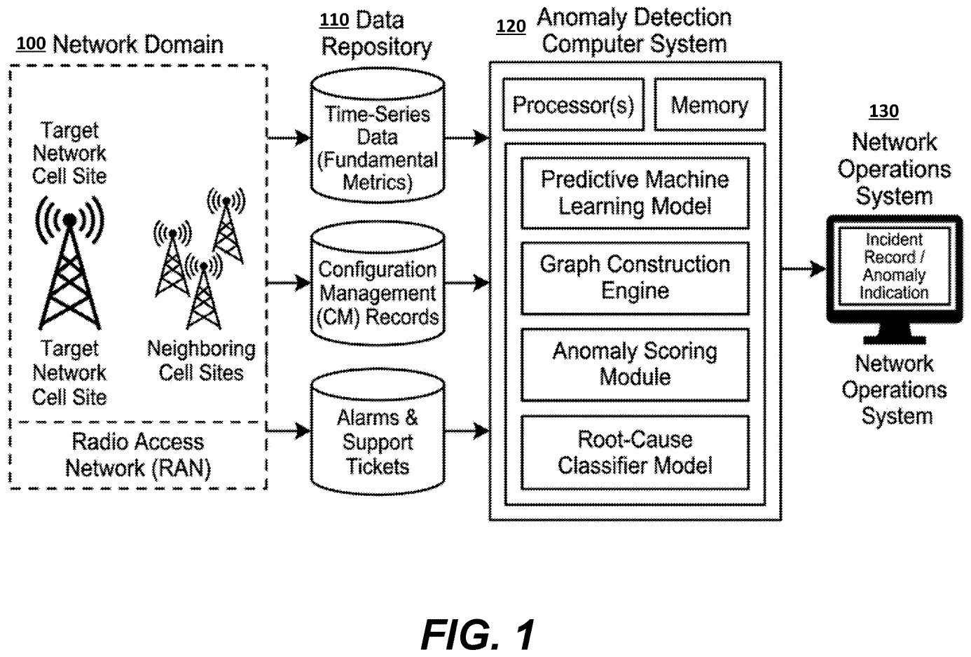

FIG. 1 illustrates an example system environment 100 for detecting anomalies and performing root-cause analysis in a radio access network (RAN), in accordance with some embodiments. In particular, FIG. 1 shows a practical deployment architecture in which network telemetry and operational records from a live RAN environment are processed by an anomaly detection computer system 120 to generate an anomaly indication or incident record for use by a network operations system 130. Thus, FIG. 1 is not merely an abstract functional block diagram, but instead illustrates an example operational environment in which the disclosed techniques may be deployed to monitor a target network cell site, identify degradation of a primary performance indicator (e.g., COM), determine one or more contributing metrics, and provide an actionable output to network operations personnel or systems.

As shown, the system environment 100 may include a network domain, a data repository 110, the anomaly detection computer system 120, and the network operations system 130. The network domain may include a target network cell site and one or more neighboring cell sites within a radio access network. The target network cell site may correspond to a base station, sector, cell, or other radio access node from which performance measurements are collected. The neighboring cell sites may provide contextual information relevant to evaluating whether detected performance degradation is local to the target network cell site or associated with broader conditions affecting multiple nearby sites.

The data repository 110 may store multiple categories of operational data used by the anomaly detection computer system 120. In the illustrated example, the data repository 110 stores time-series data including fundamental metrics, configuration management (CM) records, and alarms and support tickets. The time-series data may include performance management counters, key performance indicators, and other telemetry values collected from the target network cell site over time. Such time-series data may provide the fundamental metrics used as inputs for anomaly detection and derived-metric estimation. The CM records may identify configuration changes, software updates, parameter modifications, maintenance activities, or other operational events that may affect network behavior. The alarms and support tickets may include alarm logs, fault reports, trouble tickets, maintenance notes, and other structured or unstructured records associated with performance conditions in the RAN.

The anomaly detection computer system 120 may include one or more processors and memory configured to execute instructions for carrying out the techniques disclosed herein. In the example shown, the anomaly detection computer system 120 includes a predictive machine learning model, a graph construction engine, an anomaly scoring module, and a root-cause classifier model. These components are illustrated functionally, and may be implemented using one or more software modules, hardware modules, or combinations thereof, whether on a single computing platform or distributed across multiple computing devices.

The predictive machine learning model of the anomaly detection computer system 120 may receive the time-series data stored in the data repository 110 and generate estimated values for one or more derived metrics based on the fundamental metrics collected from the target network cell site. In some implementations, the derived metrics may correspond to performance indicators that are unobservable, delayed, unavailable, or only partially observable at the time of analysis. For example, certain user equipment quality indicators or latency-related measurements may not be immediately available due to reporting latency, limited sampling, privacy restrictions, or incomplete observability. The predictive machine learning model may therefore extend observability by inferring such derived metrics from available time-series inputs. In some embodiments, the predictive machine learning model may operate on input sequences sampled over a sliding time window and may output predicted values for a current time step or a future time step. In some embodiments, the predictive machine learning model may include, for example, a recurrent neural network (RNN), a long short-term memory (LSTM) network, a gated recurrent unit (GRU) network, a transformer-based sequence model, a temporal convolutional network (TCN), or another temporal prediction model trained on historical time-series data sampled at uniform time intervals.

The graph construction engine of the anomaly detection computer system 120 may access or construct a hierarchical dependency graph representing learned statistical relationships among the fundamental metrics, the derived metrics, and a primary performance indicator associated with the target network cell site. In some embodiments, the graph construction engine may maintain the dependency graph in memory or retrieve it from a persistent data store. The hierarchical dependency graph may be used to represent how lower-level metrics are related to one another and to higher-level performance indicators. In this way, the anomaly detection computer system 120 may evaluate not only whether a particular metric is anomalous, but also whether that metric is likely contributing to degradation of the primary performance indicator.

The anomaly scoring module of the anomaly detection computer system 120 may compute anomaly scores for the fundamental metrics and the derived metrics based on deviations from corresponding expected values during a target time window. The expected values may be determined using one or more reference techniques, including statistical baselines generated from historical data for comparable time-of-day or day-of-week windows, forecasted values generated by a time-series prediction model, predefined thresholds, or combinations thereof. The anomaly scoring module may further detect degradation of the primary performance indicator during the target time window and calculate an attribution score for at least one fundamental metric or derived metric based on the anomaly score of that metric and a graph-based relationship between that metric and the primary performance indicator in the hierarchical dependency graph. Based on that processing, the anomaly detection computer system 120 may generate an anomaly indication identifying one or more metrics that contribute to the detected degradation.

The root-cause classifier model shown in the anomaly detection computer system 120 may process additional operational information, such as the CM records and the alarms and support tickets stored in the data repository 110, to support further diagnosis of the detected anomaly. Although more detailed root-cause-analysis processing may be described with respect to later figures, FIG. 1 shows that such RCA processing may be deployed as part of the same practical RAN operations architecture that performs anomaly detection and attribution.

The network operations system 130 may receive the anomaly indication generated by the anomaly detection computer system 120 and may present and store an incident record corresponding to the target network cell site. The incident record may identify degradation of the primary performance indicator and one or more fundamental metrics or derived metrics determined to be contributing to the degradation. In this manner, the output of the disclosed processing is integrated into an operational workflow used for network monitoring, diagnosis, and response. For example, the network operations system 130 may provide the incident record to an operator console, ticketing system, assurance platform, or other network management interface for further investigation or corrective action.

A particular example in which the technical challenges addressed by FIG. 1 may become especially acute is a crowded venue, such as a stadium, arena, concert venue, festival site, or other high-density event location. In such a scenario, the target network cell site may experience rapid and highly non-stationary changes in traffic load, radio conditions, handover behavior, and user experience over short time intervals. At the same time, some relevant measurements may be delayed, partially observable, or unavailable, while neighboring cell sites may also be affected by load redistribution, interference changes, or event-driven mobility patterns. Under those conditions, conventional threshold-based monitoring may generate excessive alarms or fail to isolate the actual contributors to degradation. By contrast, the system environment 100 shown in FIG. 1 supports a practical deployment in which time-series telemetry, operational records, predictive derived-metric estimation, graph-based dependency analysis, anomaly scoring, and incident-record generation are integrated to provide more reliable anomaly detection and operationally useful outputs in such challenging RAN conditions.

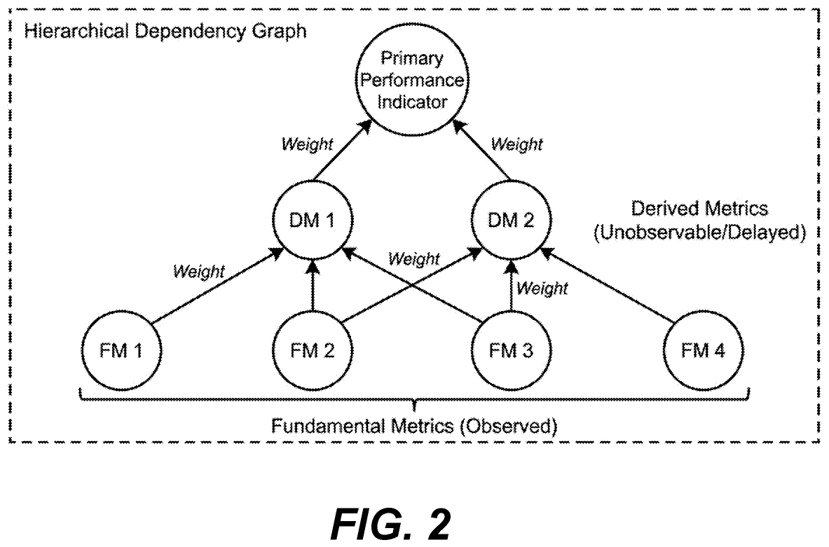

FIG. 2 illustrates an example hierarchical dependency graph 200 including fundamental metrics, derived metrics, and a primary performance indicator, in accordance with some embodiments. In the illustrated example, the hierarchical dependency graph 200 may be represented as a directed acyclic graph (DAG) in which lower-level observed metrics are arranged below higher-level inferred or aggregate indicators. As shown, the graph includes a plurality of fundamental metrics FM1, FM2, FM3, and FM4, one or more derived metrics DM1 and DM2, and a primary performance indicator at an upper level of the graph. In some embodiments, the fundamental metrics FM1-FM4 may correspond to directly observed metrics collected from a network cell site, while the derived metrics DM1 and DM2 may correspond to unobservable, delayed, unavailable, or partially observable performance indicators inferred from the observed metrics. The primary performance indicator may correspond to a higher-level indicator of network performance or service quality associated with the network cell site.

As further shown in FIG. 2, directed edges connect lower-level nodes to higher-level nodes, and one or more of the directed edges may be associated with weights. In some embodiments, each directed edge may represent a learned statistical relationship indicating that a source metric contributes to, influences, or is predictive of a target metric or indicator. For example, one or more of the fundamental metrics FM1-FM4 may contribute to a corresponding derived metric DM1 or DM2, and one or more of the derived metrics DM1 and DM2 may in turn contribute to the primary performance indicator. In some embodiments, a given fundamental metric may influence more than one higher-level node, and a given higher-level node may depend on multiple lower-level nodes. Accordingly, the hierarchical dependency graph 200 may capture multi-dimensional and cross-linked dependencies among observed metrics, derived metrics, and the primary performance indicator.

In some embodiments, the fundamental metrics FM1-FM4 shown in FIG. 2 are examples and may include, for example, performance management counters, directly observed key performance indicators, or other observed time-series values collected from a network cell site. The derived metrics DM1 and DM2 shown in FIG. 2 are examples and may include, for example, a user equipment (UE) quality metric, a cell quality-derived metric, a latency-related metric, or another performance indicator that is not directly available at the time of analysis. Thus, although FIG. 2 labels the nodes generically as FM1-FM4 and DM1-DM2 for ease of illustration, the figure is intended to show an example hierarchy in which observed lower-level metrics support estimation and analysis of higher-level and partially observable network conditions.

In some embodiments, the hierarchical dependency graph 200 may be constructed from historical time-series data associated with a network cell site or multiple network cell sites. For example, the system may evaluate candidate relationships among the fundamental metrics, the derived metrics, and the primary performance indicator by computing one or more dependency measures from historical time-series data. Such dependency measures may include, by way of example, lag correlation, mutual information, information gain, Granger-causality measures, or other statistical or temporal relationship measures. When a candidate relationship satisfies one or more criteria, a directed edge may be added between corresponding nodes in the graph, and an initial weight may be assigned to that edge based on a strength of the inferred relationship. In this manner, the hierarchical dependency graph 200 may be learned from historical network behavior rather than defined solely by manual rules or static expert configuration.

By way of a more specific example, a target network cell site serving a stadium, arena, concert venue, or other high-density event location may produce observed time-series values for fundamental metrics such as physical resource block utilization, uplink or downlink throughput, radio link failure count, handover failure rate, and random access success rate. One or more derived metrics in such an environment may correspond to UE quality, cell quality, or latency-related conditions that are not directly available at the time of anomaly analysis. For instance, a UE quality metric may depend in part on device-side measurements or delayed reports that are not immediately accessible due to reporting latency, privacy-related restrictions, sparse measurement sampling, or incomplete user equipment participation. Likewise, a latency-related metric may be delayed because it is computed from downstream aggregation or post-processing rather than from raw counters directly available at the current analysis time. In such cases, the system may train a predictive machine learning model using historical time-series data sampled at uniform time intervals, where the training data includes sequences of observed fundamental metrics together with historical values of the corresponding derived metrics when those derived metrics are available. After training, the predictive machine learning model may be used during inference to receive a current sliding-window sequence of observed values for one or more of FM1-FM4 and output an estimated current or future value for DM1 or DM2. In this manner, the system may reconstruct missing, delayed, or otherwise unavailable derived metrics for the target network cell site, thereby extending observability under challenging network conditions.

In some embodiments, the hierarchical dependency graph 200 may be iteratively refined after initial construction. For example, the system may compute estimated values of a higher-level node using values of one or more lower-level nodes and current edge weights associated with directed edges leading to the higher-level node. The estimated values may then be compared with corresponding historical observed values to determine an estimation error. Based on the estimation error, one or more edge weights may be adjusted to improve how well the graph models the observed relationships across the hierarchy. Through iterative refinement, the dependency graph may more accurately represent real statistical and temporal dependencies among the fundamental metrics, the derived metrics, and the primary performance indicator. In the venue example above, this refinement may allow the graph to learn, for example, that a combination of increasing resource utilization, degrading handover performance, and decreasing estimated UE quality has a stronger relationship to degradation of the primary performance indicator during event congestion periods than during ordinary baseline operating conditions.

In some embodiments, the hierarchical dependency graph 200 may be used during anomaly detection and attribution. For example, after anomaly scores have been computed for one or more of the fundamental metrics FM1-FM4 and one or more derived metrics DM1-DM2, the system may evaluate a graph-based relationship between an anomalous metric and the primary performance indicator to determine whether the anomalous metric contributes to degradation of the primary performance indicator. In some embodiments, the graph-based relationship may include at least one weighted path through the hierarchical dependency graph 200 connecting a particular fundamental metric or derived metric to the primary performance indicator. For example, a weighted path may extend from FM1 to DM1 and then from DM1 to the primary performance indicator, or from FM3 to DM2 and then from DM2 to the primary performance indicator.

In the venue example, FM1 may correspond to a resource-utilization metric, DM1 may correspond to an estimated UE quality metric, and the primary performance indicator may correspond to a higher-level service quality indicator for the target network cell site. If FM1 exhibits an anomalous deviation during a target time window and the weighted path from FM1 through DM1 to the primary performance indicator indicates a sufficiently strong learned dependency, the system may calculate an attribution score indicating that the anomalous increase in resource utilization is contributing to degradation of the primary performance indicator, potentially through its effect on UE quality. Similarly, an anomalous handover-related metric represented by FM3 may be linked through DM2, such as an estimated latency-related or cell-quality-derived metric, to the primary performance indicator. In such embodiments, the attribution score may be based on both the anomaly score of the metric and the weighted path or other graph-based relationship linking that metric to the primary performance indicator.

In some embodiments, the hierarchical dependency graph 200 enables the system to distinguish between metric-level abnormality and contribution to degradation of the primary performance indicator. For example, a particular fundamental metric may exhibit a large deviation during a target time window and therefore receive a relatively high anomaly score, yet may have only a weak weighted path or other weak graph-based relationship to the primary performance indicator. In such a case, the system may determine that the metric is anomalous but is not a principal contributor to the detected degradation of the primary performance indicator. Conversely, another metric may exhibit a smaller or less extreme deviation but may lie on a stronger weighted path to the primary performance indicator and therefore receive a higher attribution score as a contributing cause of the degradation. In this manner, the hierarchical dependency graph 200 supports more selective and technically meaningful attribution than approaches that rely solely on single-indicator thresholds or isolated anomaly magnitudes. For example, in a crowded venue scenario, a sudden increase in a local signaling-related metric at the target network cell site may produce a large anomaly score but may have limited learned influence on the primary performance indicator if historical data shows that such signaling spikes are often transient and weakly correlated with service degradation. By contrast, a more moderate deviation in a resource-utilization metric or a handover-related metric may be assigned a higher attribution score where the hierarchical dependency graph 200 indicates that such deviations more reliably propagate through an estimated UE quality metric or a latency-related metric to degrade the primary performance indicator. Accordingly, the disclosed graph-based approach may reduce over-attribution to visually prominent but operationally less significant deviations, while improving identification of metrics that more meaningfully contribute to service degradation.

FIG. 2 is illustrative and not limiting. In other embodiments, the hierarchical dependency graph 200 may include additional intermediate levels, additional derived metrics, direct relationships between selected fundamental metrics and the primary performance indicator, or a substantially larger number of observed and inferred metrics than those expressly shown. For example, in an operational RAN deployment, the number of fundamental metrics associated with a network cell site may be significantly larger than the four illustrated nodes FM1-FM4, and the number of derived metrics may likewise vary based on implementation. Accordingly, FIG. 2 is intended to illustrate one example of a learned hierarchical dependency structure that may be accessed or constructed by the disclosed system for graph-based anomaly analysis and attribution.

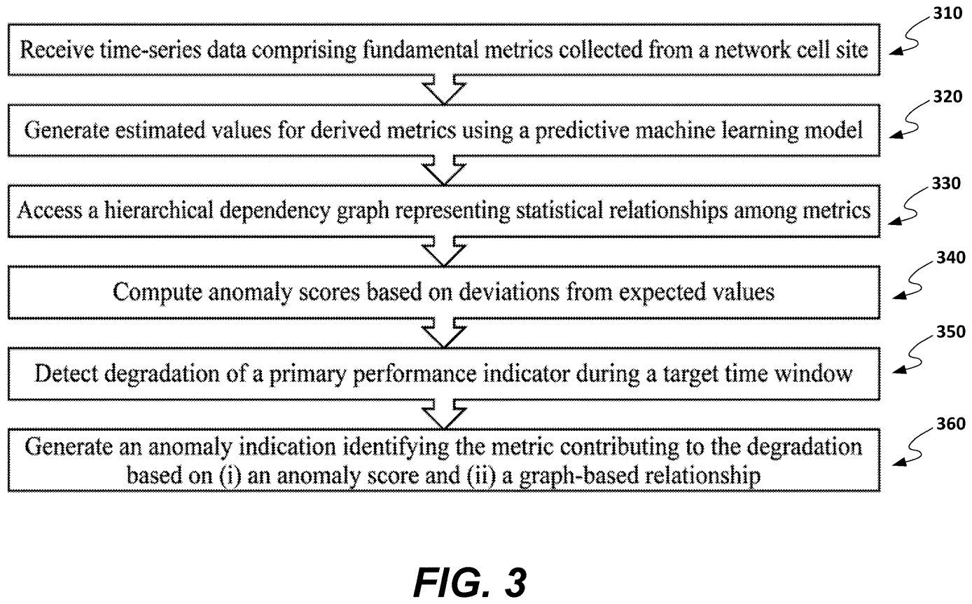

FIG. 3 illustrates an example method 300 for detecting an anomalous network condition based on derived metrics, anomaly scores, and graph-based attribution, in accordance with some embodiments. In some embodiments, the method 300 may be performed by the anomaly detection computer system described with respect to FIG. 1. Whereas FIG. 1 illustrates an example deployment environment and system architecture, FIG. 3 illustrates an example operational processing flow by which the disclosed system processes network telemetry from a target network cell site and generates an anomaly indication identifying one or more contributing metrics. Accordingly, FIG. 3 provides an example of how the disclosed techniques may be practically applied within a RAN operations workflow to detect degradation of a primary performance indicator based on both observed and inferred network metrics.

At block 310, the method 300 may include receiving time-series data comprising fundamental metrics collected from a network cell site. In some embodiments, the fundamental metrics may include directly observed metrics, such as performance management counters, key performance indicators, or other telemetry values measured over time for the target network cell site. The time-series data may be received from one or more network data repositories, assurance systems, or network management systems, and may be organized as temporally ordered sequences sampled at recurring intervals. In some implementations, the received time-series data may reflect dynamic network behavior under changing load conditions, including congestion periods, mobility events, configuration changes, or interference-related conditions affecting the network cell site.

At block 320, the method 300 may include generating estimated values for one or more derived metrics using a predictive machine learning model. In some embodiments, the derived metrics may correspond to unobservable, delayed, unavailable, or partially observable performance indicators of the network cell site. The predictive machine learning model may receive, as input, a sequence of values of the fundamental metrics sampled over a sliding time window and may output predicted values for one or more derived metrics for a current time step or a future time step. In some embodiments, the predictive machine learning model may include, for example, a recurrent neural network (RNN), a long short-term memory (LSTM) network, a gated recurrent unit (GRU) network, a transformer-based sequence model, a temporal convolutional network (TCN), or another temporal prediction model.

In some embodiments, the predictive machine learning model used at block 320 may be trained prior to deployment using historical time-series data sampled at uniform time intervals. For example, training data may include historical sequences of observed fundamental metrics together with corresponding historical values of one or more derived metrics when those derived metrics are available. Through such training, the predictive machine learning model may learn temporal and statistical relationships that permit estimation of the derived metrics during later inference when direct measurement of those derived metrics is delayed, incomplete, or unavailable. This can be particularly useful in operational scenarios in which direct observability is reduced, such as high-load event environments, rapidly changing radio conditions, or deployments in which certain user-experience or latency-related indicators are not immediately accessible at analysis time.

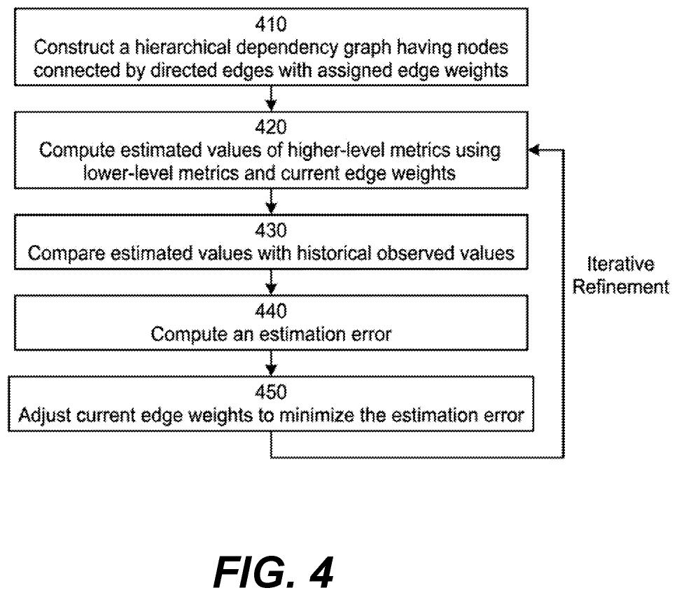

At block 330, the method 300 may include accessing a hierarchical dependency graph representing statistical relationships among metrics. In some embodiments, the hierarchical dependency graph may represent learned statistical relationships among the fundamental metrics, the derived metrics, and a primary performance indicator associated with the network cell site. Example details on the hierarchical dependency graph may be found in FIG. 4.

At block 340, the method 300 may include computing anomaly scores based on deviations from expected values. In some embodiments, anomaly scores may be computed for the fundamental metrics and the derived metrics during a target time window. The expected values may be determined in a variety of ways, including by using a statistical baseline generated from historical data for a comparable time-of-day or day-of-week window, a forecasted value generated by a time-series prediction model, a predefined threshold, or a combination thereof. Thus, block 340 may involve comparing observed or estimated metric values to contextually appropriate reference values rather than evaluating the metrics in isolation. In this manner, the method 300 may identify abnormal behavior in both directly observed metrics and reconstructed derived metrics.

At block 350, the method 300 may include detecting degradation of a primary performance indicator during a target time window. In some embodiments, the primary performance indicator may correspond to a higher-level indicator of service quality, network health, or cell-site performance. Detection of degradation of the primary performance indicator may occur based on a deviation of the primary performance indicator from an expected value, baseline range, threshold, or other decision criterion. In some embodiments, degradation detected at block 350 may indicate that the network cell site is experiencing a service-impacting condition that warrants attribution analysis to identify one or more contributing metrics.

At block 360, the method 300 may include generating an anomaly indication identifying the metric contributing to the degradation based on (i) an anomaly score and (ii) a graph-based relationship. In some embodiments, this may include calculating, for at least one fundamental metric or derived metric, an attribution score based on the anomaly score of the metric and a graph-based relationship between that metric and the primary performance indicator in the hierarchical dependency graph. The graph-based relationship may include, for example, at least one weighted path connecting the metric to the primary performance indicator. The anomaly indication may identify one or more metrics that are determined to contribute to degradation of the primary performance indicator at the network cell site.

In some embodiments, block 360 may distinguish between mere metric-level abnormality and operational contribution to degradation of the primary performance indicator. For example, a particular fundamental metric may exhibit a relatively large deviation from its expected value and thus receive a relatively high anomaly score, but may have only a weak learned relationship to the primary performance indicator in the hierarchical dependency graph. In such a case, the system may determine that the metric is anomalous but is not a principal contributor to degradation of the primary performance indicator. Conversely, another metric may exhibit a less extreme deviation but may lie on a stronger weighted path to the primary performance indicator and therefore receive a higher attribution score. In this manner, the method 300 may provide more selective and technically meaningful anomaly attribution than approaches that rely solely on individual metric thresholds or isolated anomaly magnitudes.

By way of example, in a stadium, concert venue, or other high-density event environment, the network cell site may experience abrupt increases in radio resource utilization, mobility-related failures, or contention-related latency during a relatively short period of time. Some relevant performance indicators, such as UE quality or certain latency-related conditions, may not be directly available at the time the anomaly is being evaluated. In such an environment, block 320 may reconstruct one or more such derived metrics from currently observed fundamental metrics, and block 360 may then determine, using the hierarchical dependency graph accessed at block 330, whether the anomalous behavior of a given metric is likely contributing to degradation of the primary performance indicator. For instance, a large spike in a signaling-related metric may receive a high anomaly score but may have limited contribution to the primary performance indicator if the graph indicates a weak weighted path, while a more moderate deviation in resource utilization or handover-related behavior may receive a higher attribution score due to a stronger graph-based relationship to the primary performance indicator through an estimated UE-quality or latency-related derived metric.

Although blocks 310-360 are illustrated in a particular order in FIG. 3, the order is illustrative and not limiting. In other embodiments, one or more blocks may be performed in a different order, repeated, combined, subdivided, or omitted. For example, expected-value generation may be performed as a separate sub-process, graph refinement may be performed periodically before block 330, and generation of the anomaly indication at block 360 may further include presenting or storing an incident record in a network operations system. Accordingly, FIG. 3 illustrates one example of a computer-implemented detection flow that applies learned metric estimation and learned graph-based dependency analysis to practical anomaly detection in a RAN environment.

FIG. 4 illustrates an example process 400 for constructing and iteratively refining a hierarchical dependency graph using estimation error, in accordance with some embodiments. In some embodiments, the process 400 may be performed prior to runtime anomaly detection so that a subsequently accessed hierarchical dependency graph reflects learned statistical relationships among fundamental metrics, derived metrics, and a primary performance indicator associated with a network cell site. Thus, whereas FIG. 3 illustrates an example operational flow for detecting an anomalous network condition using a previously available graph structure, FIG. 4 illustrates an example computer-implemented training and refinement process by which that graph structure may be generated and improved using historical time-series data. In this manner, FIG. 4 provides a concrete technical workflow for constructing a graph-based dependency model from RAN telemetry rather than relying on manually defined correlations or static expert rules.

At block 410, the process 400 may include constructing a hierarchical dependency graph having nodes connected by directed edges with assigned edge weights. In some embodiments, the hierarchical dependency graph may be represented as a directed acyclic graph (DAG). The nodes of the DAG may represent fundamental metrics, one or more derived metrics, and a primary performance indicator. The directed edges may define graph-based relationships among the nodes, and the assigned edge weights may represent strengths of corresponding learned dependencies. In some embodiments, construction of the graph may be based on historical time-series data collected from a target network cell site or from multiple network cell sites over time. For example, the system may evaluate candidate relationships among metrics by computing one or more dependency measures, such as lag correlation, mutual information, information gain, Granger-causality measures, or other statistical or temporal relationship measures. When a candidate relationship satisfies one or more criteria, a directed edge may be created between corresponding nodes, and an initial edge weight may be assigned based on the inferred dependency strength.

In some embodiments, the graph-construction operation at block 410 may include defining multiple hierarchical levels within the DAG. For example, lower levels may include directly observed fundamental metrics, intermediate levels may include one or more derived metrics, and an upper level may include the primary performance indicator. In one example, the fundamental metrics may include observed time-series values such as resource-utilization measurements, throughput-related measurements, handover-related measurements, radio link failure counts, random-access performance measurements, or other directly collected RAN telemetry. One or more derived metrics may include a UE quality metric, a cell quality-derived metric, a latency-related metric, or another performance indicator that is unobservable, delayed, unavailable, or partially observable at the time of runtime anomaly analysis. The primary performance indicator may correspond to a higher-level service or network performance indicator associated with the target network cell site. In some embodiments, the initial DAG constructed at block 410 may therefore encode an initial approximation of how lower-level observed and inferred metrics affect degradation of the primary performance indicator.

At block 420, the process 400 may include computing estimated values of higher-level metrics using lower-level metrics and current edge weights. In some embodiments, for a selected higher-level node in the DAG, the system may use values of one or more lower-level parent nodes together with the current edge weights associated with incoming directed edges to compute an estimated value of that higher-level node. This computation may be performed for one or more intermediate derived metrics, for the primary performance indicator, or for multiple levels of the hierarchy. In some embodiments, the estimation may be based on a weighted aggregation, a learned mapping, or another model-based dependency function that uses the graph structure and current edge weights to propagate information upward through the DAG.

At block 430, the process 400 may include comparing the estimated values with historical observed values. In some embodiments, the historical observed values may correspond to archived metric values for the same node and time interval represented by the estimated values. Thus, for a given historical time point or time window, the system may compare an estimated higher-level value generated from lower-level inputs to a corresponding historical observed value recorded in historical RAN telemetry. This comparison may be repeated across multiple time intervals, multiple nodes, multiple network cell sites, or combinations thereof.

At block 440, the process 400 may include computing an estimation error. In some embodiments, the estimation error may represent a difference between one or more estimated values and one or more corresponding historical observed values. The estimation error may be represented as an absolute error, squared error, aggregate loss value, or other discrepancy measure indicative of how accurately the current graph structure and edge weights model the historical metric relationships. In some embodiments, the estimation error may be computed separately for individual nodes, aggregated across multiple nodes within the hierarchy, aggregated across multiple time windows, or aggregated across multiple cell sites.

At block 450, the process 400 may include adjusting current edge weights to minimize the estimation error. In some embodiments, the system may update one or more edge weights associated with directed edges in the DAG so that subsequent estimated values more closely match the corresponding historical observed values. The adjustment may be performed iteratively, as indicated in FIG. 4, such that the updated edge weights are reused in a subsequent pass through block 420, followed by renewed comparison at block 430 and renewed error computation at block 440. Through repeated refinement, the graph may converge toward a dependency structure that more accurately reflects actual statistical and temporal relationships among the fundamental metrics, the derived metrics, and the primary performance indicator in the historical data.

By way of example, a target network cell site serving a stadium, arena, concert venue, or other high-density event environment may exhibit highly dynamic and non-stationary interactions among resource-utilization metrics, mobility-related metrics, and user-experience-related conditions. In such a case, historical event-period telemetry may show that degradation of a primary performance indicator is more strongly associated with a combination of increasing resource utilization, worsening handover performance, and deteriorating UE quality than would be suggested by any one metric in isolation. The process 400 shown in FIG. 4 may refine the DAG so that edge weights along paths reflecting those interactions become stronger where supported by historical data, while other weaker or less predictive relationships are reduced. In this manner, the refined graph may capture venue-specific or scenario-specific dependency behavior that would be difficult to encode accurately using static threshold logic or manual expert rules alone.

In some embodiments, the refined hierarchical dependency graph produced by process 400 may subsequently be accessed during runtime anomaly detection, such as at block 330 of FIG. 3. For example, after anomaly scores have been computed for one or more fundamental metrics and one or more derived metrics during a target time window, the refined graph may be used to evaluate a graph-based relationship, including a weighted path, between a metric and the primary performance indicator. An attribution score may then be calculated based on the anomaly score of the metric and the refined graph-based relationship. Because the graph used for attribution has been learned and iteratively refined from historical RAN telemetry, the resulting anomaly indication may better identify metrics that materially contribute to degradation of the primary performance indicator, while reducing over-attribution to metrics that may be anomalous in isolation but have limited learned influence on the primary performance indicator.

Accordingly, FIG. 4 illustrates a concrete computer-implemented process for generating and refining the hierarchical dependency graph used in the disclosed anomaly-detection architecture. Rather than treating metric relationships as fixed or manually declared, the process 400 uses historical time-series data, estimation of higher-level values from lower-level inputs, comparison against historical observed values, error computation, and iterative edge-weight adjustment to produce a refined dependency model tailored to RAN operating behavior. This refined model may then be used in practical anomaly detection and attribution workflows to improve identification of metrics contributing to degradation of a primary performance indicator at a network cell site.

Although blocks 410-450 are illustrated in a particular order in FIG. 4, the order is illustrative and not limiting. In other embodiments, one or more blocks may be repeated, subdivided, combined, supplemented, or performed in a different order. For example, candidate-edge generation may be performed as a separate preprocessing step, different estimation-error measures may be used for different levels of the hierarchy, or refinement may be performed periodically as additional historical telemetry becomes available.

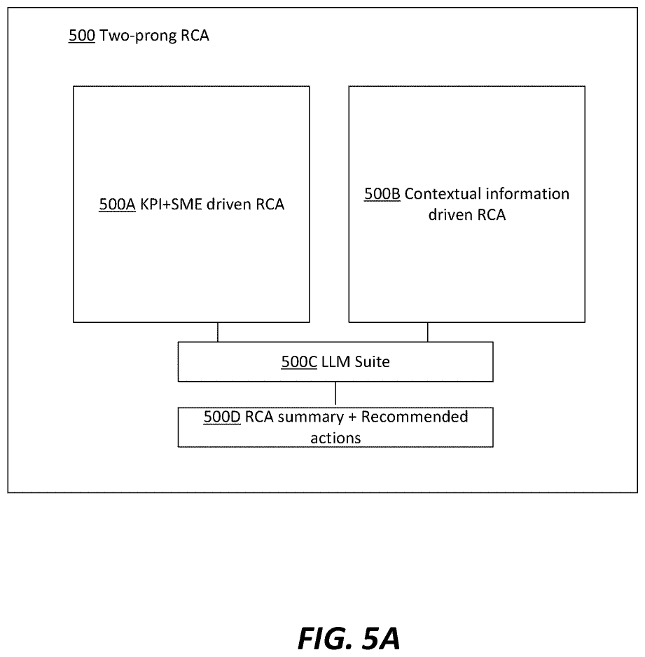

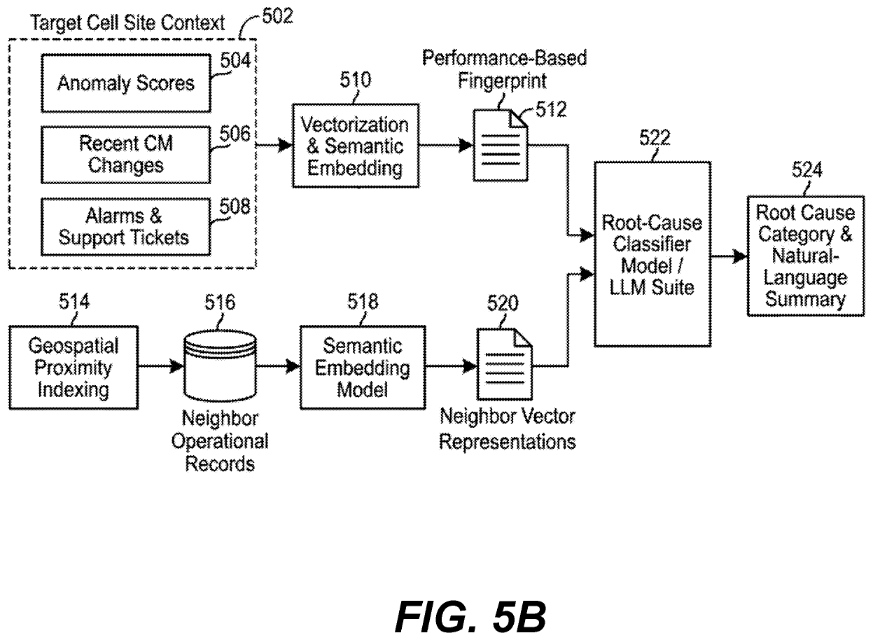

FIGS. 5A and 5B illustrate an example root-cause analysis (RCA) pipeline 500, in accordance with some embodiments. More particularly, FIG. 5A illustrates a high-level architectural view of the RCA pipeline 500, while FIG. 5B illustrates a more detailed implementation view of selected components within the RCA pipeline 500. As shown in FIG. 5A, the RCA pipeline 500 may be organized as a two-prong RCA architecture including a KPI and SME-driven RCA branch 500A and a contextual-information-driven RCA branch 500B. Outputs of the two branches may be provided to an LLM suite 500C, which may generate an RCA summary and, in some embodiments, recommended actions 500D.

In some embodiments, the KPI and SME-driven RCA branch 500A may operate primarily on structured performance data associated with a target network cell site. For example, the KPI+SME-driven RCA branch 500A may receive anomaly outputs from the anomaly-detection pipeline described above, including anomalous fundamental metrics, anomalous derived metrics, anomaly scores, graph-based attribution results, or combinations thereof. The KPI+SME-driven RCA branch 500A may further incorporate subject matter expertise (SME), such as operator knowledge, expert-defined relationships, engineering heuristics, domain-specific constraints, or operational policies, to interpret the detected anomalies in the context of known network behavior. In some embodiments, the KPI+SME-driven RCA branch 500A may use such information to identify likely degradation patterns, classify fault types, prioritize contributing metrics, or generate a structured performance-based characterization of the anomaly.

In some embodiments, the contextual-information-driven RCA branch 500B may operate primarily on contextual and operational information that is not fully captured by KPI behavior alone. For example, the contextual-information-driven RCA branch 500B may process alarms, configuration-management (CM) changes, maintenance logs, support tickets, and contextual records associated with the target network cell site and, in some embodiments, one or more neighboring cell sites. Such contextual information may help identify environmental, systemic, regional, or cascading contributors to degradation of a primary performance indicator, including causes that may be weakly reflected or not directly observable in structured metric data alone.

The two-prong structure of the RCA pipeline 500 may provide technical advantages over RCA approaches that rely on only one source of diagnostic evidence. For example, the KPI+SME-driven RCA branch 500A may be effective for identifying faults manifested through measurable deviations in fundamental metrics, derived metrics, and learned dependency relationships, but may be less effective for identifying external or operational events whose effects are not directly captured in time-series performance measurements. Conversely, the contextual-information-driven RCA branch 500B may identify events such as maintenance activity, configuration changes, neighboring-site disruptions, transport issues, environmental disturbances, or other operational causes, but may not by itself provide a sufficiently precise explanation of which metrics are degraded or how those metric degradations relate to the primary performance indicator. By combining the KPI+SME-driven RCA branch 500A and the contextual-information-driven RCA branch 500B, the RCA pipeline 500 may produce a more complete and operationally useful diagnosis than a single-source RCA technique.

In some embodiments, the KPI+SME-driven RCA branch 500A and the contextual-information-driven RCA branch 500B may both provide inputs to the LLM suite 500C. The LLM suite 500C may synthesize, interpret, summarize, or reconcile outputs from the two RCA branches to generate a unified diagnostic result. In some embodiments, the LLM suite 500C may include one or more language-model-based components configured to process structured and unstructured diagnostic evidence, generate natural-language summaries, align output information with one or more RCA taxonomies, or produce operator-facing explanations. Additional technical details of example LLM-based processing may be described in greater detail with respect to later figures.

In some embodiments, the RCA summary and recommended actions 500D may include a root-cause summary that identifies one or more likely causes of degradation of the primary performance indicator, together with a natural-language explanation of the supporting evidence. In some embodiments, the RCA summary and recommended actions 500D may further include one or more recommended actions, such as operator review actions, parameter-adjustment recommendations, troubleshooting suggestions, field-maintenance recommendations, or other remedial measures. Thus, FIG. 5A illustrates a high-level view of how the RCA pipeline 500 combines performance-based evidence and contextual operational information to generate a unified RCA output for a target network cell site.

By way of example, in a high-density venue environment such as a stadium, concert venue, or festival site, the KPI+SME-driven RCA branch 500A may identify anomalous resource-utilization behavior, handover-related degradation, or derived-metric degradation indicating reduced UE quality or increased latency, while the contextual-information-driven RCA branch 500B may identify related support tickets, neighboring-site alarms, temporary configuration changes, or other contextual events occurring in the same time period. The RCA pipeline 500 may combine those distinct evidence sources through the LLM suite 500C to generate an RCA summary and recommended actions 500D that are more complete than an output based on KPI anomalies alone or contextual records alone.

FIG. 5B illustrates a more detailed example implementation of the root-cause analysis (RCA) pipeline introduced in FIG. 5A, in accordance with some embodiments. In particular, FIG. 5B shows an example flow by which performance-based information associated with a target network cell site and contextual information associated with neighboring cell sites may be transformed into structured vector representations and analyzed to generate a root-cause category and natural-language summary. In some embodiments, FIG. 5B corresponds to an example implementation of the KPI+SME-driven RCA branch 500A and the contextual-information-driven RCA branch 500B of FIG. 5A.

As shown in FIG. 5B, the RCA pipeline may process target cell site context 502. In some embodiments, the target cell site context 502 may include anomaly scores 504, recent configuration-management (CM) changes 506, and alarms and support tickets 508 associated with the target network cell site. The anomaly scores 504 may correspond to anomaly scores computed for one or more fundamental metrics and one or more derived metrics, as described above. The recent CM changes 506 may include records of parameter modifications, configuration updates, software changes, maintenance actions, or other operational events associated with the target network cell site. The alarms and support tickets 508 may include alarm logs, incident records, support records, maintenance notes, or other operational text and event information associated with the target network cell site.

In some embodiments, the target cell site context 502 may be provided to a vectorization and semantic embedding module 510. The vectorization and semantic embedding module 510 may generate a performance-based fingerprint 512 for the target network cell site. In some embodiments, the performance-based fingerprint 512 may comprise a vectorized representation of multiple categories of information associated with the target network cell site. For example, the performance-based fingerprint 512 may include anomaly scores associated with fundamental metrics and derived metrics, numerical encodings of recent CM changes 506, numerical encodings of alarms and support ticket activity 508, and one or more semantic embeddings generated by processing textual content of the CM changes 506 and the alarms and support tickets 508. In some embodiments, to preserve consistent dimensionality across different cell sites and analysis instances, non-anomalous metrics may be assigned predetermined default values in the vectorized representation, while anomalous metrics may be represented using their anomaly scores or other corresponding values.

In some embodiments, the semantic processing performed by the vectorization and semantic embedding module 510 may include converting free-text operational records into one or more embedding vectors that preserve semantic relationships among terms, phrases, incident descriptions, or maintenance notes. For example, textual content describing a parameter rollback, hardware replacement, congestion event, neighbor outage, or repeated alarm condition may be transformed into one or more semantic embeddings that can be incorporated into the performance-based fingerprint 512. In this manner, the performance-based fingerprint 512 may combine structured anomaly evidence and operational-record context in a unified representation suitable for downstream RCA classification.

FIG. 5B further shows a neighboring-site contextual branch including geospatial proximity indexing 514, neighbor operational records 516, a semantic embedding model 518, and neighbor vector representations 520. In some embodiments, the geospatial proximity indexing 514 may identify one or more neighboring cell sites based on geospatial proximity to the target network cell site. For example, the geospatial proximity indexing 514 may use one or more spatial indexing or nearest-neighbor techniques to identify nearby cell sites whose operational state may be relevant to diagnosing the target network cell site. After neighboring cell sites have been identified, the system may retrieve neighbor operational records 516, which may include neighbor support tickets, neighbor alarm logs, neighbor configuration-change records, maintenance records, or other contextual operational information associated with the neighboring cell sites.

In some embodiments, the semantic embedding model 518 may process textual content of the neighbor operational records 516 to generate neighbor vector representations 520. The neighbor vector representations 520 may capture semantic patterns in neighboring-site events that may indicate environmental, regional, cascading, or system-wide contributors to degradation of the primary performance indicator at the target network cell site. For example, if multiple neighboring cell sites have temporally related alarms, transport-related trouble tickets, weather-related maintenance notes, or similar configuration-change patterns, the semantic embedding model 518 may produce neighbor vector representations 520 that reflect those contextual relationships. In this manner, the neighboring-site branch of FIG. 5B may provide evidence beyond the target cell site's own metrics and records.

In some embodiments, the performance-based fingerprint 512 and the neighbor vector representations 520 may be provided to a root-cause classifier model/LLM suite 522. The root-cause classifier model/LLM suite 522 may classify the degradation of the primary performance indicator into a root-cause category and may generate a natural-language summary 524 describing the likely cause or causes of the detected degradation. In some embodiments, the root-cause classifier model/LLM suite 522 may include a machine learning classifier trained on historical fingerprints labeled with root-cause categories, a language-model-based component configured to synthesize and explain RCA outputs, or a combination thereof. Thus, the root-cause classifier model/LLM suite 522 may use both the target-cell performance-based fingerprint 512 and the neighboring-site contextual representations 520 to identify likely local, environmental, or system-wide contributing causes.

In some embodiments, FIG. 5B may be understood as a more detailed implementation example of the high-level RCA architecture shown in FIG. 5A. More specifically, the target cell site context 502, the vectorization and semantic embedding module 510, and the performance-based fingerprint 512 may correspond primarily to an implementation of the KPI+SME-driven RCA branch 500A, while the geospatial proximity indexing 514, neighbor operational records 516, semantic embedding model 518, and neighbor vector representations 520 may correspond primarily to an implementation of the contextual-information-driven RCA branch 500B. The root-cause classifier model/LLM suite 522 and the resulting root-cause category and natural-language summary 524 may correspond to an example implementation of the LLM suite 500C and the RCA summary and recommended actions 500D shown in FIG. 5A.

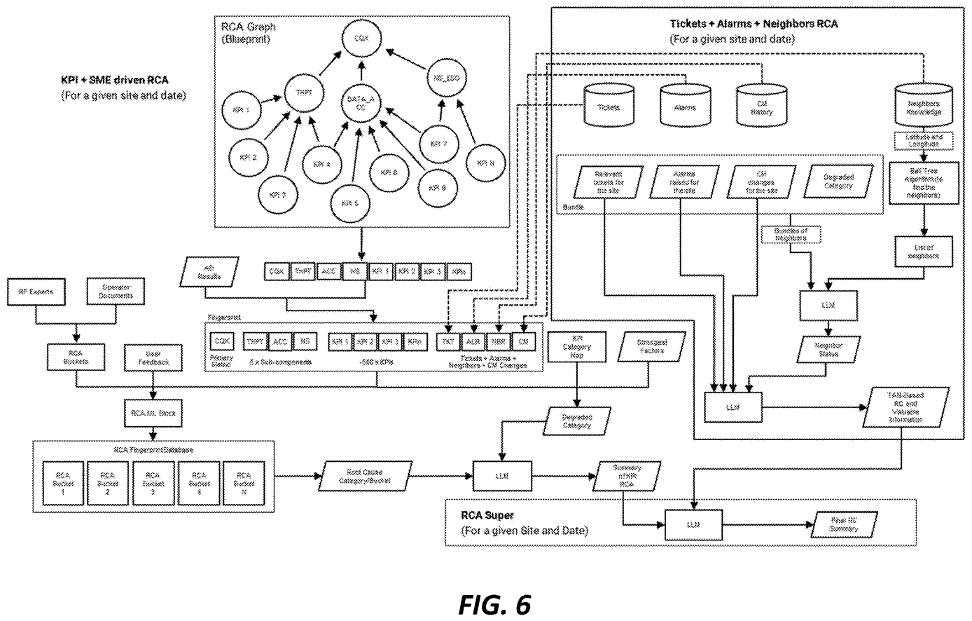

FIG. 6, described below, illustrates a further example implementation in which the RCA concepts of FIGS. 5A and 5B are realized using a more specific workflow. In particular, FIG. 6 shows a more specific two-prong root-cause analysis architecture combining KPI-driven analysis and contextual operational-record analysis, in which a KPI+SME Driven RCA branch and a Tickets+Alarms+Neighbors RCA branch operate for a given site and date and provide outputs to an RCA Super layer that generates a Final RC Summary. As such, FIG. 6 may be understood as a more concrete implementation example of the higher-level two-prong RCA architecture shown in FIG. 5A and the functional pipeline shown in FIG. 5B.

As shown on the left side of FIG. 6, the KPI+SME Driven RCA branch may receive AD Results for a target network cell site together with information derived from an RCA Graph Blueprint. In some embodiments, the AD Results may include anomaly scores or anomaly indicators associated with one or more fundamental metrics and one or more derived metrics, including metrics determined to be contributing to degradation of a primary performance indicator. The RCA Graph Blueprint may correspond to a learned dependency structure, such as the hierarchical dependency graph described above, and may be used to contextualize the relationships among the anomalous metrics and the primary performance indicator.

The KPI+SME Driven RCA branch may further receive or use information from RF Experts, Operator Documents, RCA Buckets, and User Feedback. In some embodiments, RF Experts and Operator Documents may provide engineering knowledge, expert-defined RCA taxonomies, operator procedures, or other domain-specific guidance relevant to interpretation of anomalous network behavior. User Feedback may be used to confirm, correct, or refine RCA results over time. The RCA Buckets may correspond to a set of known RCA categories or issue classes maintained by the system.

In some embodiments, the KPI+SME Driven RCA branch may generate a Fingerprint for the target network cell site. The Fingerprint may be a performance-based fingerprint corresponding, for example, to the performance-based fingerprint described with respect to FIG. 5B. As shown in FIG. 6, the Fingerprint may include positions corresponding to multiple metric and context entries so as to preserve a consistent dimensional structure. In some embodiments, anomalous fundamental metrics and anomalous derived metrics may be encoded using their anomaly scores or other numerical values indicative of deviation severity, while non-anomalous metrics may be assigned predetermined default values to preserve fingerprint dimensionality across different cell sites and time intervals. The Fingerprint may further include encoded values corresponding to recent configuration-management changes, alarms, tickets, neighboring-site context, or other operational data.

In some embodiments, the Fingerprint may be provided to an RCA ML Block, which may compare the Fingerprint against a set of RCA Buckets maintained in an RCA Fingerprint Database. The RCA Buckets may correspond to previously learned, labeled, or otherwise defined RCA categories, such as congestion issues, mobility failures, interference-related degradations, transport failures, configuration-related degradations, hardware-related failures, or other network issue types. In some embodiments, the RCA ML Block may comprise a supervised machine learning model trained on historical fingerprints associated with known RCA categories. In some embodiments, the RCA ML Block may further be refined using User Feedback and additional expert input.

As further shown in FIG. 6, the KPI+SME Driven RCA branch may use a KPI Category Map and Strongest Factors to determine a Degraded Category. In some embodiments, the Strongest Factors may correspond to one or more anomalous metrics having relatively strong graph-based attribution to degradation of the primary performance indicator, while the KPI Category Map may associate such metrics with one or more functional network domains, such as throughput, mobility, accessibility, congestion, latency, or quality. The Degraded Category may therefore characterize the operational impact associated with the anomaly condition detected at the target network cell site.

In some embodiments, the KPI+SME Driven RCA branch may produce a Root Cause Category/Bucket and a Summary of KPI RCA. The Root Cause Category/Bucket may be generated by the RCA ML Block based on the Fingerprint and the RCA Buckets, and the Summary of KPI RCA may be generated by an LLM that produces a narrative explanation based on the Root Cause Category/Bucket, the Degraded Category, the Strongest Factors, and other structured evidence associated with the target network cell site.

As shown on the right side of FIG. 6, the Tickets+Alarms+Neighbors RCA branch may process contextual operational information for the same target network cell site and date. In some embodiments, this branch may access Tickets, Alarms, and CM History, and may retrieve, for example, Relevant tickets for the site, Alarms raised for the site, and CM changes for the site. In some embodiments, the Tickets+Alarms+Neighbors RCA branch may also receive or use a Degraded Category as contextual information for downstream reasoning.

The Tickets+Alarms+Neighbors RCA branch may further process neighboring-site context. In the illustrated example, Neighbors Knowledge may provide information identifying candidate neighboring cell sites, and a Ball Tree Algorithm to find the neighbors may be used to determine a List of neighbors associated with the target network cell site. In some embodiments, the List of neighbors may identify one or more geographically proximate cell sites whose conditions may be relevant to the detected degradation. This may allow the system to account for environmental, regional, or cascading causes that are not evident from the target cell site's own metric behavior alone.

In some embodiments, the Relevant tickets for the site, Alarms raised for the site, CM changes for the site, Degraded Category, and List of neighbors may be provided to one or more LLM processing blocks. The LLM processing blocks may process structured and unstructured contextual data to determine, for example, a Neighbor Status and a TAN-Based RC and Valuable Information output. In some embodiments, the TAN-Based RC and Valuable Information output may identify likely environmental or system-wide contributing causes, such as coordinated configuration rollouts across neighboring sites, regional transport issues, a neighboring-site outage producing coverage or load redistribution effects, localized event-driven traffic surges, or other contextual conditions influencing degradation of the primary performance indicator at the target network cell site.

In some embodiments, outputs from the KPI+SME Driven RCA branch and the Tickets+Alarms+Neighbors RCA branch may be provided to an RCA Super layer for the given site and date. As shown, the RCA Super layer may include an LLM that receives the Summary of KPI RCA and the TAN-Based RC and Valuable Information output and generates a Final RC Summary. In some embodiments, the Final RC Summary may integrate structured metric-based RCA evidence with contextual operational evidence to produce a unified explanation of the detected degradation. The Final RC Summary may identify both a likely root cause category and the operational impact of the issue, together with supporting contextual events or neighboring-site conditions.

By way of example, in a stadium, concert venue, festival site, or other high-density environment, the KPI+SME Driven RCA branch may determine from the AD Results, the Strongest Factors, and the Degraded Category that the target network cell site is experiencing a throughput-related or mobility-related degradation associated with a particular Root Cause Category/Bucket. At the same time, the Tickets+Alarms+Neighbors RCA branch may determine from Tickets, Alarms, CM History, Neighbors Knowledge, and the Ball Tree Algorithm to find the neighbors that one or more nearby cell sites experienced coordinated congestion alarms, temporary configuration changes, or transport issues during the same period. The RCA Super layer may then combine those complementary evidentiary streams to generate a Final RC Summary indicating, for example, that a venue-driven traffic surge, combined with neighboring-site load redistribution and recent parameter changes, is a likely cause of the detected degradation.

In some embodiments, FIG. 6 may be viewed as a more specific implementation example of the more general flow shown in FIG. 5B. For example, the Fingerprint, RCA ML Block, RCA Buckets, Root Cause Category/Bucket, and Summary of KPI RCA shown in FIG. 6 may correspond to more specific examples of the Performance-Based Fingerprint and Root-Cause Classifier Model/LLM Suite shown in FIG. 5B. Similarly, the Tickets, Alarms, CM History, Neighbors Knowledge, Ball Tree Algorithm to find the neighbors, List of neighbors, TAN-Based RC and Valuable Information, and Final RC Summary shown in FIG. 6 may correspond to more specific examples of the geospatial proximity indexing, neighbor operational records, neighbor vector representations, and Root Cause Category & Natural-Language Summary shown in FIG. 5B.

Although FIG. 6 shows particular data sources, processing blocks, and output artifacts, the illustrated arrangement is exemplary and not limiting. In other embodiments, one or more LLM blocks may be replaced or supplemented by other machine learning models, one or more RCA categories may be dynamically learned or updated, and the RCA Super layer may further generate confidence values, recommended actions, remediation suggestions, or other operator-facing outputs. Accordingly, FIG. 6 illustrates one example of a concrete multi-stage RCA workflow in which KPI-based evidence and contextual operational evidence are jointly processed to generate a Final RC Summary for a target network cell site.

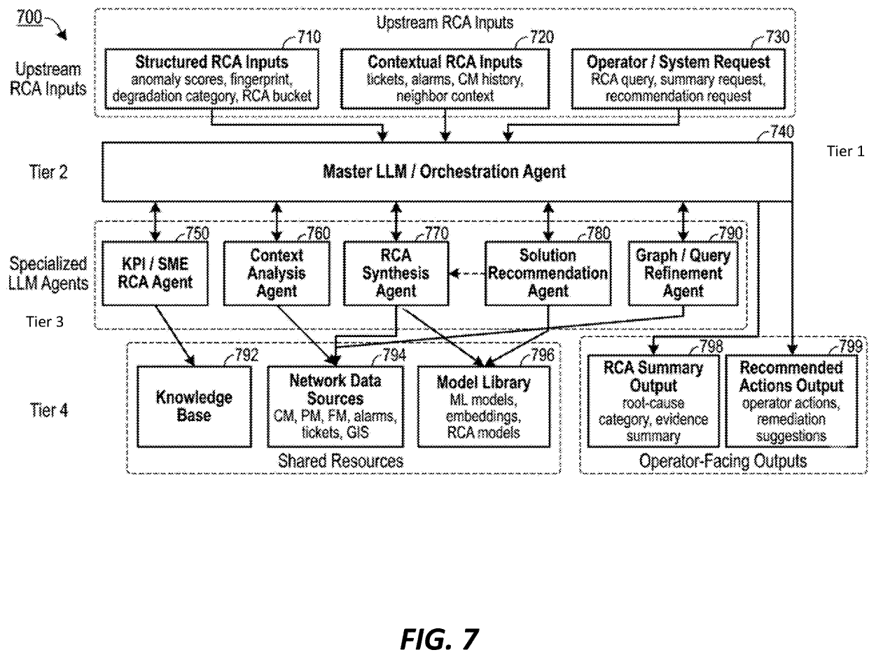

FIG. 7 illustrates an example modular large language model (LLM) suite architecture 700 used in anomaly detection (AD), root-cause analysis (RCA), and recommendation generation in a radio access network (RAN), in accordance with some embodiments.

In some embodiments, the architecture 700 may serve as an orchestration and synthesis layer that receives structured RCA inputs, contextual RCA inputs, and operator or system requests, coordinates a plurality of specialized LLM agents, accesses shared resources, and produces operator-facing outputs such as RCA summaries and recommended actions. Thus, FIG. 7 may represent an example architecture by which structured anomaly information and contextual operational information are transformed into unified natural-language explanations and actionable recommendations.

As shown, the architecture 700 may include an upstream RCA inputs layer having structured RCA inputs 710, contextual RCA inputs 720, operator or system requests 730, another suitable input, or any combination thereof. The structured RCA inputs 710 may include, for example, anomaly scores, a performance-based fingerprint, a degradation category, an RCA bucket, or other outputs from the anomaly-detection and RCA workflows described in FIGS. 1-6. The contextual RCA inputs 720 may include tickets, alarms, configuration-management (CM) history, neighbor context, or other contextual operational information. The operator or system requests 730 may include, for example, an RCA query, a summary request, a recommendation request, or another request provided by an operator, network operations system, or automated control system. In some embodiments, the upstream RCA inputs may therefore include both machine-generated diagnostic artifacts and human- or system-initiated requests for interpretation, summarization, or remediation guidance.

The structured RCA inputs 710, contextual RCA inputs 720, and operator or system requests 730 may be provided to a master LLM/orchestration agent 740. In some embodiments, the master LLM/orchestration agent 740 may function as a central routing, coordination, and synthesis component of the architecture 700. For example, the master LLM/orchestration agent 740 may determine which subsets of input information should be processed by which specialized agents, may issue task-specific prompts or instructions to those agents, may receive intermediate outputs from those agents, and may combine the returned outputs into a unified response. In some embodiments, the master LLM/orchestration agent 740 may further enforce formatting rules, apply consistency checks across agent outputs, resolve conflicts among multiple candidate explanations, rank competing hypotheses, or select among alternative downstream actions.

In the illustrated example, the architecture 700 further includes a specialized LLM agents layer having a KPI/SME RCA agent 750, a context analysis agent 760, an RCA synthesis agent 770, a solution recommendation agent 780, and a graph/query refinement agent 790. In some embodiments, each of the agents 750-790 may be configured to perform a respective task or semantic role within the overall RCA and recommendation workflow. The master LLM/orchestration agent 740 may communicate bidirectionally with the specialized agents 750-790 so that the master LLM/orchestration agent 740 can delegate tasks, receive outputs, request follow-up analysis, or iteratively refine a response based on partial results returned by one or more of the specialized agents 750-790.

In some embodiments, the KPI/SME RCA agent 750 may process structured RCA artifacts associated with metric-level anomaly analysis and subject-matter-expert reasoning. For example, the KPI/SME RCA agent 750 may interpret anomaly scores, graph-based attribution results, performance-based fingerprints, degradation categories, or RCA bucket assignments, and may align such information with expert-defined RCA taxonomies, engineering heuristics, operator practices, or domain rules. The KPI/SME RCA agent 750 may therefore help translate structured network-performance evidence into a candidate root-cause interpretation that is technically grounded and aligned with operator knowledge.

In some embodiments, the context analysis agent 760 may process contextual RCA inputs 720, such as tickets, alarms, CM history, and neighbor context. For example, the context analysis agent 760 may analyze support-ticket narratives, alarm histories, maintenance events, parameter changes, neighboring-site disturbances, or other contextual signals to identify environmental, regional, systemic, or cascading contributors to a detected degradation. In some embodiments, the context analysis agent 760 may extract event sequences, correlate temporally related records, or generate semantic summaries of contextual evidence for later use by the RCA synthesis agent 770 or the master LLM/orchestration agent 740.

In some embodiments, the RCA synthesis agent 770 may combine outputs from the KPI/SME RCA agent 750 and the context analysis agent 760 to generate a candidate root-cause explanation or evidence summary. For example, the RCA synthesis agent 770 may reconcile structured metric-based RCA evidence with contextual operational evidence, generate an integrated explanation of likely root causes, or prepare a natural-language or semantically structured RCA result for delivery to the master LLM/orchestration agent 740. In some embodiments, the RCA synthesis agent 770 may apply consistency checks, evidence weighting, reasoning templates, or confidence-ranking logic when combining results from multiple sources.

In some embodiments, the solution recommendation agent 780 may generate one or more recommended actions responsive to a diagnosed anomaly or root cause. For example, the solution recommendation agent 780 may propose operator actions, remediation suggestions, reconfiguration steps, escalation procedures, maintenance recommendations, script-generation suggestions, or other corrective measures. In some embodiments, the solution recommendation agent 780 may use the RCA output together with domain-specific rules, previously successful interventions, policy constraints, or operator preferences to rank candidate actions. In some embodiments, the solution recommendation agent 780 may distinguish between advisory recommendations for operator review and actions eligible for semi-automated or automated execution.

In some embodiments, the graph/query refinement agent 790 may refine or augment analytical inputs used by the architecture 700. For example, the graph/query refinement agent 790 may update, refine, or validate portions of an RCA graph or dependency structure used in RCA processing. Additionally or alternatively, the graph/query refinement agent 790 may generate or reformulate queries for retrieving supporting evidence from network data sources, including queries directed to CM, PM, FM, alarm, ticket, or GIS repositories. In some embodiments, the graph/query refinement agent 790 may therefore enable dynamic retrieval of additional evidence responsive to an operator request or a need identified by the master LLM/orchestration agent 740 during synthesis.

As further shown in FIG. 7, the specialized LLM agents may access shared resources including a knowledge base 792, network data sources 794, and a model library 796. In some embodiments, the knowledge base 792 may store domain-specific information used to support interpretation, reasoning, and recommendation generation. For example, the knowledge base 792 may include operator manuals, RCA taxonomies, remediation playbooks, network engineering guidelines, historical incident summaries, prior RCA cases and their resolutions, approved troubleshooting procedures, alarm-code dictionaries, configuration-parameter definitions, mappings between KPIs and network functional domains, maintenance policies, escalation rules, and operator-authored best-practice documents. In some embodiments, the knowledge base 792 may further include structured templates for RCA summary generation, recommendation-ranking rules, and policy constraints governing whether a proposed action is advisory only, approval-gated, or eligible for automated execution.

In some embodiments, the network data sources 794 may include live, recent, or historical operational data repositories from which factual evidence is retrieved during RCA processing. For example, the network data sources 794 may include configuration-management (CM) records, performance-management (PM) data, fault-management (FM) data, alarm logs, support tickets, geospatial information system (GIS) data, topology records, and neighboring-site operational data. In this regard, the contextual RCA inputs 720 and the network data sources 794 may overlap in content type but differ in role within the architecture 700. More specifically, the contextual RCA inputs 720 may represent the subset of contextual information already assembled, preprocessed, or provided to the architecture 700 for a current RCA task, such as tickets, alarms, CM history, and neighbor context associated with a given site and time window. By contrast, the network data sources 794 may represent the broader underlying repositories from which additional raw or semi-processed evidence can be retrieved on demand by one or more specialized agents. Thus, the contextual RCA inputs 720 may be viewed as task-scoped input artifacts, whereas the network data sources 794 may be viewed as backing data systems available for further evidence retrieval, validation, or enrichment during orchestration.

In some embodiments, the model library 796 may include machine learning models, embedding models, RCA models, anomaly-detection models, forecasting models, clustering models, ranking models, or other analytical models used by the architecture 700. For example, the model library 796 may include semantic embedding models for tickets, alarms, and CM records; supervised RCA classifiers trained on historical fingerprints and RCA labels; anomaly-detection models for metric scoring; predictive models for derived-metric estimation; and recommendation-ranking models used to prioritize candidate remedial actions. In some embodiments, different specialized agents may selectively invoke different models from the model library 796 depending on task type.

In some embodiments, models in the model library 796 may be maintained and updated through a model-management workflow. For example, newly collected historical telemetry, newly labeled RCA cases, operator feedback, resolved incident records, and updated policy documents may be incorporated into periodic retraining or fine-tuning cycles. Embedding models may be updated to improve semantic handling of domain-specific terminology appearing in ticket narratives, alarm text, CM notes, or operator-authored documents. RCA models may be retrained or recalibrated using newly confirmed RCA bucket assignments, corrected classifications, or newly emerging RCA categories. Similarly, anomaly-detection, forecasting, and ranking models may be retrained using more recent operational data so that the behavior captured by the models remains aligned with current network conditions, software configurations, and equipment behavior.

In some embodiments, models in the model library 796 may be tested and validated before deployment or broader use by the architecture 700. For example, an updated model may be evaluated against one or more validation sets, benchmark datasets, historical replay scenarios, or holdout incident cases to assess classification accuracy, ranking quality, semantic retrieval quality, calibration, false-positive behavior, or consistency of recommendation generation. In some embodiments, candidate models may be compared against previously deployed models using offline evaluation metrics, shadow-mode deployment, limited-scope rollout, or human-review workflows before being promoted for wider use. The architecture 700 may therefore use the model library 796 not merely as a static repository, but as a managed collection of versioned analytical components subject to update, testing, validation, and controlled deployment.

In some embodiments, one or more specialized agents may selectively access one or more of the shared resources depending on task type. For example, the KPI/SME RCA agent 750 may access the knowledge base 792 to align structured RCA findings with expert-defined taxonomies and remediation policies, the context analysis agent 760 may access the network data sources 794 to retrieve or validate contextual evidence for a current RCA task, and the RCA synthesis agent 770, solution recommendation agent 780, or graph/query refinement agent 790 may access the model library 796 to invoke embedding, RCA, ranking, graph-refinement, or recommendation models as needed.

In some embodiments, the master LLM/orchestration agent 740 may not merely dispatch requests statically, but may perform dynamic orchestration based on the content of the received inputs and the state of intermediate results. For example, the master LLM/orchestration agent 740 may determine that a first-pass RCA explanation generated from the structured RCA inputs 710 is incomplete, and may therefore invoke the context analysis agent 760 to retrieve and interpret contextual evidence from tickets, alarms, or neighboring-site records. In another example, the master LLM/orchestration agent 740 may determine that available evidence is insufficient to support a high-confidence RCA summary, and may invoke the graph/query refinement agent 790 to obtain additional supporting evidence or refine one or more graph-based relationships before requesting updated synthesis from the RCA synthesis agent 770.

In some embodiments, outputs of the architecture 700 may include an RCA summary output 798 and a recommended actions output 799. The RCA summary output 798 may include, for example, a root-cause category, an evidence summary, a natural-language RCA explanation, supporting metric or event references, or a confidence indication. The recommended actions output 799 may include operator actions, remediation suggestions, escalation recommendations, or other intervention proposals. In some embodiments, the RCA summary output 798 and the recommended actions output 799 may be provided to an operator interface, a network operations system, an orchestration platform, or another downstream system for review, storage, execution, or further processing.

By way of example, a target network cell site serving a stadium, concert venue, or other high-density event environment may experience degradation during a short time window characterized by anomalous resource utilization, reduced UE quality, and mobility-related instability. In such an example, the structured RCA inputs 710 may include anomaly scores, a performance-based fingerprint, and a degradation category derived from the anomaly-detection workflow, while the contextual RCA inputs 720 may include alarms, tickets, CM history, and neighboring-site context indicating related congestion or configuration events. The master LLM/orchestration agent 740 may route the structured RCA inputs 710 to the KPI/SME RCA agent 750, route the contextual RCA inputs 720 to the context analysis agent 760, invoke the RCA synthesis agent 770 to produce an integrated RCA explanation, and invoke the solution recommendation agent 780 to generate recommended actions such as traffic-management adjustments, parameter review, or escalation. If additional evidence is needed, the master LLM/orchestration agent 740 may further invoke the graph/query refinement agent 790 to retrieve supporting information from the network data sources 794 or to refine portions of the dependency model before finalizing the RCA summary output 798 and the recommended actions output 799.

In some embodiments, the architecture 700 may further support policy-aware recommendation generation and execution gating. For example, the solution recommendation agent 780 may generate a set of candidate actions, while the master LLM/orchestration agent 740 may rank, filter, or suppress such actions based on policy constraints, operational risk levels, approval requirements, or previously stored remediation rules in the knowledge base 792. In some embodiments, the recommended actions output 799 may therefore distinguish between informational recommendations, approval-gated recommendations, and machine-executable recommendations.

Accordingly, FIG. 7 illustrates one example of a modular LLM-suite architecture in which a master LLM/orchestration agent 740 coordinates multiple specialized agents, accesses shared knowledge and data resources, and produces operator-facing RCA and remediation outputs. Although the architecture 700 is illustrated using particular agent types and resource categories, the arrangement is exemplary and not limiting. In other embodiments, one or more specialized agents may be added, removed, combined, or subdivided, different routing or synthesis logic may be used, and one or more outputs may be directed to other downstream systems.

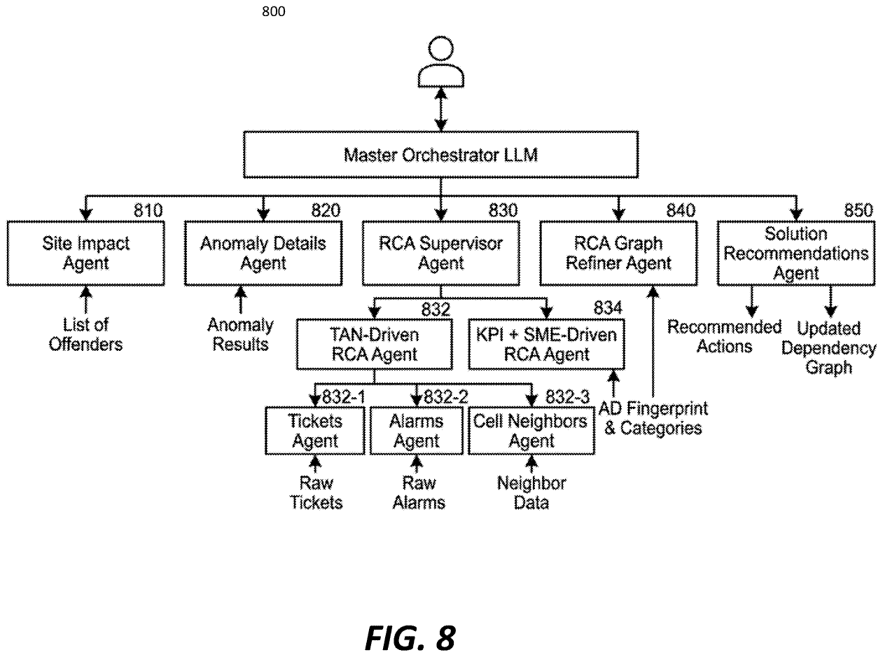

FIG. 8 illustrates an example agent-level implementation 800 of a modular LLM suite for anomaly detection, root-cause analysis (RCA), graph refinement, and recommendation generation in a radio access network (RAN), in accordance with some embodiments. In some embodiments, the implementation 800 may be viewed as a more specific embodiment of the higher-level orchestration architecture described with respect to FIG. 7. More specifically, FIG. 8 shows an example agent hierarchy in which a master orchestrator LLM coordinates a plurality of specialized agents that process anomaly details, site-level impact information, RCA results, contextual evidence, graph-refinement tasks, and solution recommendations.

As shown, the implementation 800 includes a Master Orchestrator LLM. In some embodiments, the Master Orchestrator LLM may receive an operator request, a system-generated RCA request, or another anomaly-related input, and may decompose the request into multiple subtasks suitable for processing by downstream specialized agents. The Master Orchestrator LLM may then route information to one or more specialized agents, receive intermediate outputs from those agents, and synthesize the returned outputs into a unified RCA explanation, updated dependency information, or a set of recommended actions. In some embodiments, the Master Orchestrator LLM may further determine whether additional evidence is required, whether a prior RCA result should be refined, or whether a recommendation should be suppressed, revised, or escalated based on available evidence or policy constraints.

In the illustrated example, the Master Orchestrator LLM communicates with a Site Impact Agent 810, an Anomaly Details Agent 820, an RCA Supervisor Agent 830, an RCA Graph Refiner Agent 840, and a Solution Recommendations Agent 850. In some embodiments, each of these agents may be implemented as a task-specialized language-model agent, a prompt-specialized execution context, or another modular reasoning component configured to process a particular type of input or perform a particular analytical function.

In some embodiments, the Site Impact Agent 810 may receive a List of Offenders and generate an interpretation of site-level impact based on those offenders. The List of Offenders may include, for example, an ordered or ranked list of anomalous fundamental metrics or derived metrics that have been determined to contribute to degradation of a primary performance indicator. The Site Impact Agent 810 may analyze such offenders to determine, for example, which functional domains are affected, whether the degradation appears localized or broad within the target network cell site, and how the identified offenders may relate to service-level impact.

In some embodiments, the Anomaly Details Agent 820 may receive Anomaly Results and generate a more detailed characterization of the detected anomalies. For example, the Anomaly Results may include anomaly scores, expected-value deviations, time-window information, metric-level trends, or graph-based attribution outputs from the anomaly-detection workflow described above. The Anomaly Details Agent 820 may summarize the significance of the anomalous metrics, identify temporal patterns or severity indicators, and prepare anomaly-specific evidence for use by the RCA Supervisor Agent 830 or the Master Orchestrator LLM.

In some embodiments, the RCA Supervisor Agent 830 may coordinate one or more RCA-specific sub-agents to generate a more comprehensive RCA result. In the illustrated example, the RCA Supervisor Agent 830 communicates with a TAN-Driven RCA Agent 832 and a KPI+SME-Driven RCA Agent 834. The RCA Supervisor Agent 830 may therefore act as an intermediate orchestration layer specialized for RCA-related reasoning, allowing the Master Orchestrator LLM to delegate RCA subtasks without directly managing every lower-level evidence source.

In some embodiments, the KPI+SME-Driven RCA Agent 834 may receive AD Fingerprint & Categories and generate an RCA result based on structured anomaly information and expert-aligned classifications. The AD Fingerprint & Categories may include, for example, a performance-based fingerprint, one or more RCA bucket assignments, a degraded category, strongest factors, or related structured RCA artifacts derived from the KPI-driven RCA processing described above. The KPI+SME-Driven RCA Agent 834 may interpret such information in view of subject matter expertise, operator taxonomies, or known RCA categories to generate a candidate root-cause explanation based primarily on structured metric evidence.

In some embodiments, the TAN-Driven RCA Agent 832 may generate an RCA result based on contextual operational information, such as tickets, alarms, and neighboring-cell evidence. As shown, the TAN-Driven RCA Agent 832 may communicate with a Tickets Agent 832-1, an Alarms Agent 832-2, and a Cell Neighbors Agent 832-3. In some embodiments, the Tickets Agent 832-1 may receive Raw Tickets and extract issue narratives, symptom descriptions, time correlations, escalation indicators, or other ticket-derived contextual evidence. The Alarms Agent 832-2 may receive Raw Alarms and identify alarm patterns, severity sequences, recurring conditions, or likely fault relationships. The Cell Neighbors Agent 832-3 may receive Neighbor Data and identify neighboring-site conditions, adjacent-cell disturbances, correlated regional issues, or load-redistribution effects relevant to the target network cell site. The TAN-Driven RCA Agent 832 may synthesize these ticket-, alarm-, and neighbor-based findings into a contextual RCA output for use by the RCA Supervisor Agent 830.

In some embodiments, the RCA Supervisor Agent 830 may combine the outputs of the TAN-Driven RCA Agent 832 and the KPI+SME-Driven RCA Agent 834 to generate a coordinated RCA result, or may provide both outputs upward to the Master Orchestrator LLM for final synthesis. In some embodiments, the RCA Supervisor Agent 830 may compare competing hypotheses generated by the two RCA paths, request additional analysis from one branch if the evidence is incomplete, or prioritize one path over the other depending on the nature of the detected anomaly.

In some embodiments, the RCA Graph Refiner Agent 840 may receive AD Fingerprint & Categories and may generate an Updated Dependency Graph. For example, the RCA Graph Refiner Agent 840 may refine, validate, or augment graph-based relationships used in the anomaly-detection and RCA workflow, such as portions of the hierarchical dependency graph or an RCA graph blueprint. In some embodiments, the RCA Graph Refiner Agent 840 may use structured RCA outputs, contextual evidence, or newly retrieved information to adjust confidence levels associated with graph relationships, identify missing graph links, or recommend modifications to the dependency structure.

In some embodiments, the Solution Recommendations Agent 850 may generate Recommended Actions based on RCA outputs produced elsewhere in the implementation 800. For example, the Solution Recommendations Agent 850 may propose operator actions, remediation suggestions, escalation paths, reconfiguration steps, maintenance actions, or other corrective measures responsive to a diagnosed root cause. In some embodiments, the Solution Recommendations Agent 850 may also provide information that contributes to an Updated Dependency Graph, for example where a proposed action depends on confirmation of a particular inferred dependency or where feedback from prior actions is used to refine graph relationships. In other embodiments, the outputs “Recommended Actions” and “Updated Dependency Graph” may be produced independently, as shown.

In some embodiments, the implementation 800 may support dynamic, multi-stage reasoning. For example, the Master Orchestrator LLM may initially route Anomaly Results to the Anomaly Details Agent 820 and a List of Offenders to the Site Impact Agent 810, receive preliminary interpretations, and then invoke the RCA Supervisor Agent 830 to obtain candidate RCA results from the TAN-Driven RCA Agent 832 and the KPI+SME-Driven RCA Agent 834. If the resulting explanation is incomplete or inconsistent, the Master Orchestrator LLM may invoke the RCA Graph Refiner Agent 840 to update a graph-based dependency representation or invoke the Solution Recommendations Agent 850 to test whether a proposed recommendation is consistent with the inferred RCA. In this manner, the implementation 800 may support iterative orchestration, staged evidence gathering, and cross-agent refinement of RCA and recommendation outputs.

In some embodiments, one or more of the agents shown in FIG. 8 may interact with external data repositories, knowledge resources, or model resources of the type described above with respect to FIG. 7, even though such resources are not expressly drawn in FIG. 8. For example, the Tickets Agent 832-1, Alarms Agent 832-2, and Cell Neighbors Agent 832-3 may retrieve or process contextual evidence from ticketing systems, alarm systems, or neighboring-site data repositories. The KPI+SME-Driven RCA Agent 834 may access RCA taxonomies, historical RCA cases, or performance-based fingerprints. The RCA Graph Refiner Agent 840 may access graph structures, RCA graph blueprints, or model outputs associated with dependency analysis. The Solution Recommendations Agent 850 may access remediation playbooks, policy constraints, or prior intervention records to rank candidate actions.

Accordingly, FIG. 8 illustrates one example of an agent-level implementation 800 in which a Master Orchestrator LLM coordinates multiple specialized agents to analyze anomaly details, evaluate site-level impact, supervise RCA processing, refine graph structures, and generate solution recommendations. Although FIG. 8 shows a particular hierarchy of agents and outputs, the arrangement is exemplary and not limiting. In other embodiments, one or more agents may be added, removed, combined, or subdivided, and one or more outputs may be reformulated or redirected to other downstream systems. FIG. 8 is therefore intended to illustrate a concrete example of specialized-agent orchestration within a broader LLM-suite architecture for RAN anomaly detection and RCA.

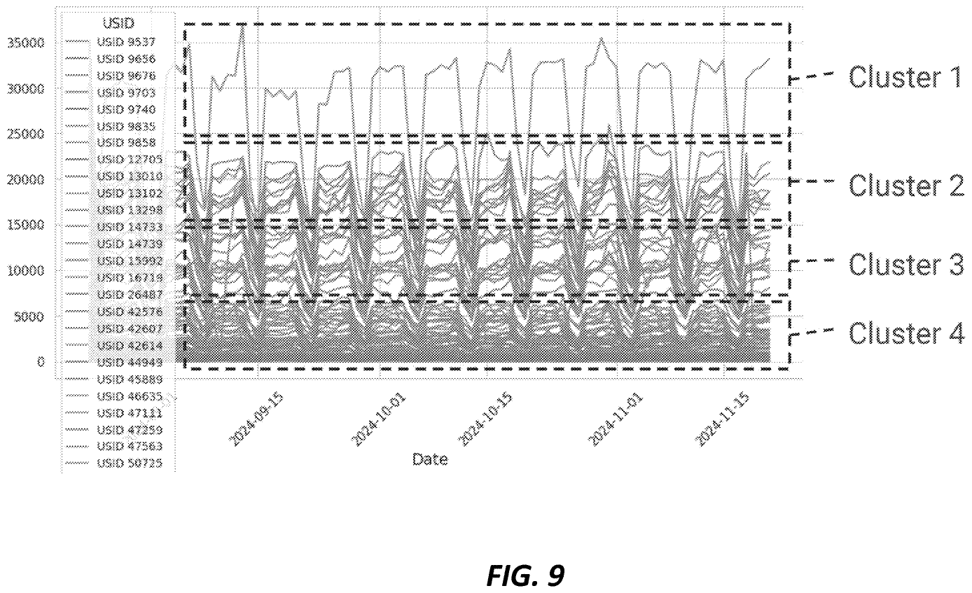

FIG. 9 illustrates an example clustered modeling approach for selecting predictive machine learning models based on temporal behavior of metric series, in accordance with some embodiments. In some embodiments, the clustered modeling approach shown in FIG. 9 may be used upstream of the derived-metric estimation stage in the overall anomaly-detection workflow. More specifically, before generating estimated values for one or more derived metrics from observed fundamental metrics, the system may first assign the fundamental metrics, or corresponding metric series from one or more network cell sites, to clusters having similar temporal behavior. A predictive machine learning model may then be selected from a plurality of predictive machine learning models respectively trained for different clusters.

As shown in FIG. 9, multiple time-series traces may be grouped into different clusters, labeled for example as Cluster 1, Cluster 2, Cluster 3, and Cluster 4, based on similarities in temporal behavior. In some embodiments, each plotted trace may correspond to a metric series associated with a network cell site, sector, user segment, or other monitored RAN entity. The metric series may represent directly observed fundamental metrics collected over time from multiple network cell sites. Different clusters may exhibit different value ranges, spike frequencies, periodic behaviors, or other temporal characteristics. For example, Cluster 1 may contain relatively high-value metric series with recurring peaks, while Cluster 4 may contain lower-value metric series with a different amplitude profile.

In some embodiments, clustering may be performed using historical time-series data associated with the fundamental metrics. The system may normalize the metric series, compute similarity scores among the metric series using one or more temporal similarity measures, and assign the metric series to clusters using one or more clustering techniques. Each cluster may then be associated with a respective predictive machine learning model trained using historical time-series data for the metric series assigned to that cluster.

During runtime, when time-series data comprising observed fundamental metrics is received for a target network cell site, the system may determine a cluster assignment for the corresponding metric series and select the predictive machine learning model associated with that cluster. The selected model may receive a sliding-window sequence of values of the fundamental metrics and output estimated values for one or more derived metrics for a current time step or a future time step. The estimated derived metrics may then be provided to downstream anomaly-detection processing, such as anomaly scoring and graph-based attribution.

The clustered modeling approach shown in FIG. 9 may improve scalability and predictive accuracy by avoiding both a separate predictive model for every metric-cell-site combination and a single undifferentiated predictive model across all metric behaviors. Accordingly, FIG. 9 illustrates one example of how the disclosed system may use clusters of metric series having similar temporal behavior to select an appropriate predictive machine learning model within the broader RAN anomaly-detection workflow.

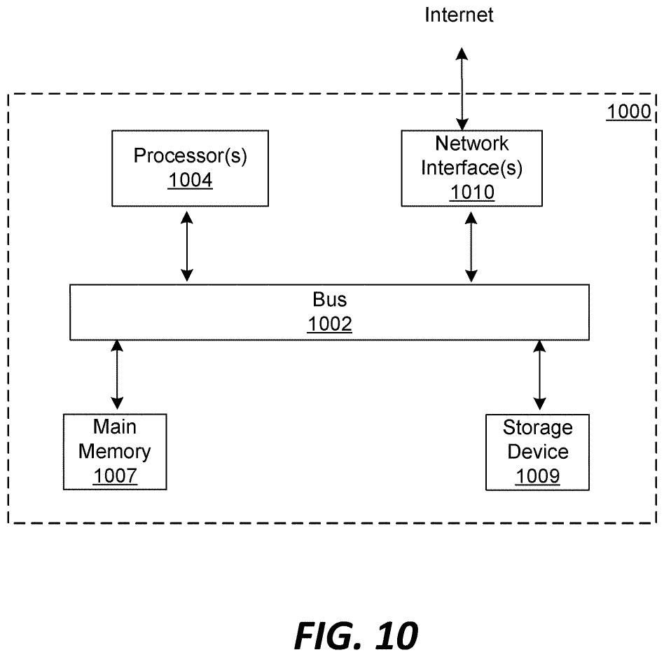

FIG. 10 illustrates an example computing device in which any of the embodiments described herein may be implemented. The computing device may be used to implement one or more components of the systems and the methods shown in FIGS. 2-7. The computing device 1000 may comprise a bus 1002 or other communication mechanisms for communicating information and one or more hardware processors 1004 coupled with bus 1002 for processing information. Hardware processor(s) 1004 may be, for example, one or more general-purpose microprocessors.

The computing device 1000 may also include a main memory 1007, such as a random-access memory (RAM), cache, and/or other dynamic storage devices, coupled to bus 1002 for storing information and instructions to be executed by processor(s) 1004. Main memory 1007 also may be used for storing provisional variables or other intermediate information during the execution of instructions to be executed by processor(s) 1004. Such instructions, when stored in storage media accessible to processor(s) 1004, may render computing device 1000 into a special-purpose machine that is customized to perform the operations specified in the instructions. Main memory 1007 may include non-volatile media and/or volatile media. Non-volatile media may include, for example, optical or magnetic disks. Volatile media may include dynamic memory. Common forms of media may include, for example, a floppy disk, a flexible disk, hard disk, solid-state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, or networked versions of the same.

The computing device 1000 may implement the techniques described herein using customized hard-wired logic, one or more ASICs or FPGAs, firmware and/or program logic which in combination with the computing device may cause or program computing device 1000 to be a special-purpose machine. According to one embodiment, the techniques herein are performed by computing device 1000 in response to processor(s) 1004 executing one or more sequences of one or more instructions contained in main memory 1007. Such instructions may be read into main memory 1007 from another storage medium, such as storage device 1009. Execution of the sequences of instructions contained in main memory 1007 may cause processor(s) 1004 to perform the process steps described herein. For example, the processes/methods disclosed herein may be implemented by computer program instructions stored in main memory 1007. When these instructions are executed by processor(s) 1004, they may perform the steps as shown in corresponding figures and described above. In alternative embodiments, hard-wired circuitry may be used in place of or in combination with software instructions.

The computing device 1000 also includes a communication interface 1010 coupled to bus 1002. Communication interface 1010 may provide a two-way data communication coupling to one or more network links that are connected to one or more networks. As another example, communication interface 1010 may be a local area network (LAN) card to provide a data communication connection to a compatible LAN (or WAN component to communicate with a WAN). Wireless links may also be implemented.

Certain operations may be performed in a distributed manner among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor-executable non-volatile computer-readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be composed in program codes or instructions stored in a memory (e.g., a non-transitory computer-readable storage medium described above). Such an algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

Certain of the operations may be performed in a distributed manner among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is in fact disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The terms “include” or “comprise” are used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A method for detecting anomalies in a radio access network (RAN), the method comprising:
receiving, by a computer system, time-series data comprising a plurality of fundamental metrics collected from a network cell site;
generating, by the computer system, estimated values for one or more derived metrics using a predictive machine learning model based on the time-series data, wherein the one or more derived metrics correspond to unobservable or delayed performance indicators of the network cell site;
accessing, by the computer system, a hierarchical dependency graph representing learned statistical relationships among the fundamental metrics, the one or more derived metrics, and a primary performance indicator associated with the network cell site;
computing, by the computer system, anomaly scores for the fundamental metrics and the one or more derived metrics based on deviations from corresponding expected values during a target time window;
detecting, by the computer system, degradation of the primary performance indicator during the target time window;
calculating, by the computer system, for at least one fundamental metric or derived metric, an attribution score based on (i) the anomaly score of the at least one fundamental metric or derived metric and (ii) a graph-based relationship between the at least one fundamental metric or derived metric and the primary performance indicator in the hierarchical dependency graph; and
generating, by the computer system, an anomaly indication for the network cell site that identifies the at least one fundamental metric or derived metric as contributing to the degradation of the primary performance indicator.

2. The method of claim 1, wherein generating the estimated values for the one or more derived metrics comprises:
applying the predictive machine learning model to an input sequence of values of the fundamental metrics sampled over a sliding time window to output predicted values for the one or more derived metrics for a current time step or a future time step.

3. The method of claim 1, wherein the predictive machine learning model comprises one or more of:
a recurrent neural network (RNN), a long short-term memory (LSTM) network, a gated recurrent unit (GRU) network, a transformer-based sequence model, or a temporal convolutional network (TCN);
wherein the method further comprises training the predictive machine learning model to learn temporal and statistical relationships based on historical time-series data sampled at uniform time intervals.

4. The method of claim 1, wherein the one or more derived metrics comprise at least one of: a user equipment (UE) quality metric, a cell quality-derived metric, or a latency-related metric.

5. The method of claim 1, further comprising, prior to accessing the hierarchical dependency graph:
constructing the hierarchical dependency graph as a directed acyclic graph (DAG), wherein nodes in the DAG represent the fundamental metrics, the one or more derived metrics, and the primary performance indicator, and wherein directed edges between the nodes define the graph-based relationship; and
iteratively refining the graph-based relationship by:
computing estimated values of higher-level metrics using lower-level metrics based on current edge weights of the directed edges;
comparing the estimated values with corresponding historical observed values to compute an estimation error; and
adjusting the current edge weights to minimize the estimation error.

6. The method of claim 1, wherein the corresponding expected values are determined based on at least one of: (i) a statistical baseline generated from historical data for a comparable time-of-day or day-of-week window, (ii) a forecasted value generated by a time-series prediction model, or (iii) a predefined threshold.

7. The method of claim 1, further comprising:
generating a performance-based fingerprint for the network cell site, the performance-based fingerprint comprising a vectorized representation of:
the anomaly scores of the fundamental metrics and the one or more derived metrics, wherein non-anomalous metrics are assigned predetermined default values to preserve a consistent fingerprint dimensionality;
numerical encodings of recent configuration management changes, alarms, and support ticket activity associated with the network cell site; and
one or more semantic embeddings generated by processing textual content of the alarms, the support ticket activity, and the recent configuration management changes; and
applying a root-cause classifier model to the performance-based fingerprint to classify the degradation of the primary performance indicator into a root cause category.

8. The method of claim 7, further comprising:
identifying one or more neighboring cell sites based on geospatial proximity to the network cell site;
retrieving operational records comprising neighbor support tickets, neighbor alarm logs, and neighbor configuration change records for the one or more neighboring cell sites;
processing the operational records using a semantic embedding model to convert textual content into neighbor vector representations; and
identifying an environmental or system-wide contributing cause to the degradation of the primary performance indicator of the network cell site based on the neighbor vector representations.

9. The method of claim 1, wherein the graph-based relationship used to calculate the attribution score comprises at least one weighted path in the hierarchical dependency graph connecting the at least one fundamental metric or derived metric to the primary performance indicator.

10. The method of claim 1, wherein the fundamental metrics are assigned to a cluster of network cell sites or metric series having similar temporal behavior, and
wherein the predictive machine learning model is selected from a plurality of predictive machine learning models respectively trained for different clusters.

11. The method of claim 1, wherein generating the anomaly indication for the network cell site comprises:
presenting and storing an incident record identifying the degradation of the primary performance indicator and the at least one fundamental metric or derived metric contributing to the degradation in a network operations system.

12. A system for detecting an anomalous network condition in a radio access network (RAN), the system comprising:
one or more processors; and
a memory storing instructions that, when executed by the one or more processors, cause the system to:
receive time-series data comprising a plurality of fundamental metrics collected from a network cell site;
generate estimated values for one or more derived metrics using a predictive machine learning model based on the time-series data, wherein the one or more derived metrics correspond to unobservable or delayed performance indicators of the network cell site;
access a hierarchical dependency graph representing learned statistical relationships among the fundamental metrics, the one or more derived metrics, and a primary performance indicator associated with the network cell site;
compute anomaly scores for the fundamental metrics and the one or more derived metrics based on deviations from corresponding expected values during a target time window;
detect degradation of the primary performance indicator during the target time window;
calculate, for at least one fundamental metric or derived metric, an attribution score based on (i) the anomaly score of the at least one fundamental metric or derived metric and (ii) a graph-based relationship between the at least one fundamental metric or derived metric and the primary performance indicator in the hierarchical dependency graph; and
generate an anomaly indication for the network cell site that identifies the at least one fundamental metric or derived metric as contributing to the degradation of the primary performance indicator.

13. The system of claim 12, wherein the instructions, when executed by the one or more processors, cause the system to:
generate the estimated values for the one or more derived metrics by applying the predictive machine learning model to an input sequence of values of the fundamental metrics sampled over a sliding time window to output predicted values for the one or more derived metrics for a current time step or a future time step, and
wherein the predictive machine learning model comprises one or more of:
a recurrent neural network (RNN), a long short-term memory (LSTM) network, a gated recurrent unit (GRU) network, a transformer-based sequence model, or a temporal convolutional network (TCN).

14. The system of claim 12, wherein the instructions, when executed by the one or more processors, cause the system to, prior to accessing the hierarchical dependency graph:
construct the hierarchical dependency graph as a directed acyclic graph (DAG), wherein nodes in the DAG represent the fundamental metrics, the one or more derived metrics, and the primary performance indicator, and wherein directed edges between the nodes define the graph-based relationship; and
iteratively refine the graph-based relationship by:
computing estimated values of higher-level metrics using lower-level metrics based on current edge weights of the directed edges;
comparing the estimated values with corresponding historical observed values to compute an estimation error; and
adjusting the current edge weights to minimize the estimation error.

15. The system of claim 12, wherein the graph-based relationship used to calculate the attribution score comprises at least one weighted path in the hierarchical dependency graph connecting the at least one fundamental metric or derived metric to the primary performance indicator.

16. The system of claim 12, wherein the instructions, when executed by the one or more processors, further cause the system to:
generate a performance-based fingerprint for the network cell site, the performance-based fingerprint comprising a vectorized representation of:
anomaly scores of the fundamental metrics and the one or more derived metrics, wherein non-anomalous metrics are assigned predetermined default values to preserve a consistent fingerprint dimensionality;
numerical encodings of recent configuration management changes, alarms, and support ticket activity associated with the network cell site; and
one or more semantic embeddings generated from textual content associated with the recent configuration management changes, the alarms, and the support ticket activity; and
apply a root-cause classifier model to the performance-based fingerprint to classify the degradation of the primary performance indicator into a root-cause category.

17. The system of claim 12, wherein generating the anomaly indication for the network cell site comprises:
presenting and storing an incident record identifying the degradation of the primary performance indicator and the at least one fundamental metric or derived metric contributing to the degradation in a network operations system.

18. A non-transitory computer-readable medium storing instructions that, when executed by one or more processors of a computer system, cause the computer system to:
receive time-series data comprising a plurality of fundamental metrics collected from a network cell site;
generate estimated values for one or more derived metrics using a predictive machine learning model based on the time-series data, wherein the one or more derived metrics correspond to unobservable or delayed performance indicators of the network cell site;
access a hierarchical dependency graph representing learned statistical relationships among the fundamental metrics, the one or more derived metrics, and a primary performance indicator associated with the network cell site;
compute anomaly scores for the fundamental metrics and the one or more derived metrics based on deviations from corresponding expected values during a target time window;
detect degradation of the primary performance indicator during the target time window;
calculate, for at least one fundamental metric or derived metric, an attribution score based on (i) the anomaly score of the at least one fundamental metric or derived metric and (ii) a graph-based relationship between the at least one fundamental metric or derived metric and the primary performance indicator in the hierarchical dependency graph; and
generate an anomaly indication for the network cell site that identifies the at least one fundamental metric or derived metric as contributing to the degradation of the primary performance indicator.

19. The non-transitory computer-readable medium of claim 18, wherein the instructions, when executed by the one or more processors, cause the computer system to, prior to accessing the hierarchical dependency graph:
construct the hierarchical dependency graph as a directed acyclic graph (DAG), wherein nodes in the DAG represent the fundamental metrics, the one or more derived metrics, and the primary performance indicator, and wherein directed edges between the nodes define the graph-based relationship; and
iteratively refine the graph-based relationship by:
computing estimated values of higher-level metrics using lower-level metrics based on current edge weights of the directed edges;
comparing the estimated values with corresponding historical observed values to compute an estimation error; and
adjusting the current edge weights to minimize the estimation error.

20. The non-transitory computer-readable medium of claim 18, wherein generating the anomaly indication for the network cell site comprises:
presenting and storing an incident record identifying the degradation of the primary performance indicator and the at least one fundamental metric or derived metric contributing to the degradation in a network operations system.
